(19) United States
(12) Patent Application Publication
(10) Pub. No.: US 2026/0170469 A1
(43) Pub. Date: Jun. 18, 2026

(54) SYSTEM AND METHOD FOR ENTITY MATCHING USING MULTIPLE PREFERENCE SETS

(71) Applicant: Junlue Zhao, Chicago, IL (US)

(72) Inventor: Junlue Zhao, Chicago, IL (US)

(21) Appl. No.: 19/411,230

(22) Filed: Dec. 6, 2025

Related U.S. Application Data
(60) Provisional application No. 63/728,696, filed on Dec. 6, 2024.

(51) Int. Cl. G06Q 10/42; G06F 3/0481; G06F 16/34

(52) U.S. Cl. CPC G06Q 10/42; G06F 3/0481; G06F 16/345

(57) ABSTRACT

An embodiment of a system and method for entity matching, facilitating discovery between matchable entities (e.g., users seeking romantic partners), includes a plurality of electronic devices associated with a plurality of users and a network connecting the plurality of electronic devices to a server of the system. A first matchable entity creates a plurality of possibly related preference sets. The server transmits other matchable entities corresponding to at least one of the plurality of possibly related preference sets to an electronic device associated with the first matchable entity.

### TECHNICAL FIELD

This disclosure relates to a system and method for entity matching and, more particularly, to a system and method for entity matching using a plurality of possibly related preference sets.

### BACKGROUND

Modern matchmaking websites, such as employment websites, social websites, dating websites and, more recently, mobile dating applications, have been around for approximately three decades, providing users across the globe an easier way to find and connect with people or entities of interest. Online dating websites and applications have increased in popularity over the years and now constitute one of the most popular ways to meet a potential partner.

While these platforms have produced successful outcomes, they are slow, tedious, inflexible, and limiting to use. It is reported that the average active user spends approximately one hour per day on multiple platforms. Each of these platforms comprises a plurality of matchable entities (e.g., users seeking romantic partners), each associated with a profile and a limit of one preference set (generally referred to as “a user's preferences”). A matchable entity's profile includes parameters or traits that describe the matchable entity, while the matchable entity's preference set may include inputs (e.g., filters) that describe whom or what the matchable entity is seeking to match with.

While it may suffice to have one profile per user, it is erroneous to limit each user to just one preference set. While every person has one body and one story, human wants and adaptability are boundless, as is often observed. At any one time, a user online is open to multiple possibly disparate or compromised matches while still having their eyes set on a desired match. In the most important aspects of life, such as one's career or romantic partner, most people, when seeking these matches, face a unique conundrum: the immediate need to compromise versus the ultimate want to not compromise.

In particular, matching for romance using a single preference set is inflexible, slow, tedious, and limiting to use.

A strong need has arisen for a better solution that enables users to match, by orders of magnitude, more efficiently and user-friendly with the multitude of possibly disparate, compromised, and/or desired entities of mutual interest or like-mindedness.

### SUMMARY

This disclosure relates generally to an entity matching process system and method. One implementation of a computer-implemented method for entity matching includes storing a plurality of matchable entity profiles (PMEP) in at least one database (database), the PMEP associated with a plurality of matchable entities (PME), the PME associated with a plurality of users (PU); receiving a plurality of preference sets (PPS) associated with a first matchable entity of the PME, the PPS electronically submitted by a first user of the PU using at least one electronic device, the first user associated with the first matchable entity, the PPS satisfying at least one of: all conforming to a first preference superset, all associating with a first mode, all associating with a first space, all associating with a first environment, all comprising related matching contexts, all comprising related intentions, all comprising related goals, all comprising related purposes, all relating to seeking professional connections, all relating to seeking employment, all relating to seeking platonic companions, and all relating to seeking at least one of romantic partners and sexual partners; and performing at least one of: transmitting a computer-readable representation of at least one matchable entity of the PME that corresponds to at least one preference set of the PPS to at least one electronic device associated with the first user, hereafter referred to as matches; transmitting a computer-readable representation of zero matches to at least one electronic device associated with the first user; and rendering a display representing zero matches on at least one electronic device associated with the first user.

One implementation of a system for entity matching includes at least one database (database) adapted to electronically store a plurality of matchable entity profiles (PMEP), the PMEP associated with a plurality of matchable entities (PME), the PME associated with a plurality of users (PU); a plurality of electronic devices (PED) associated with the PU; and a network adapted to connect the PU via the PED to a server, the server adapted to: receive a plurality of preference sets (PPS) associated with a first matchable entity of the PME, the PPS electronically submitted by a first user of the PU using at least one electronic device, the first user associated with the first matchable entity, the PPS satisfying at least one of: all conforming to a first preference superset, all associating with a first mode, all associating with a first space, all associating with a first environment, all comprising related matching contexts, all comprising related intentions, all comprising related goals, all comprising related purposes, all relating to seeking professional connections, all relating to seeking employment, all relating to seeking platonic companions, and all relating to seeking at least one of romantic partners and sexual partners; and perform at least one of: transmit a computer-readable representation of at least one matchable entity of the PME that corresponds to at least one preference set of the PPS to at least one electronic device associated with the first user, hereafter referred to as matches; transmit a computer-readable representation of zero matches to at least one electronic device associated with the first user; and render a display representing zero matches on at least one electronic device associated with the first user.

Variations in these and other aspects of the disclosure will be described in additional detail hereafter.

### BRIEF DESCRIPTION OF THE DRAWINGS

The description herein makes reference to the accompanying drawings wherein like reference numerals and letters refer to like parts throughout the several views, and wherein:

FIG. 1 illustrates a field implementation of a first illustrated embodiment of an exemplary system for entity matching, system 10, in which aspects of the disclosure can be implemented;

FIG. 2 is a schema diagram showing three illustrated embodiments of matchable entity profiles;

FIG. 3 is an interactive graphical user interface screen diagram showing an illustrated exemplary embodiment of a preference superset (PSS) template of system 10;

FIG. 3A is flow diagram showing an illustrated embodiment of a matchmaking process 50 (MMP 50) assigned to an exemplary PSS.

FIG. 4 is a schema diagram showing an illustrated embodiment of a matchable entity 28 with an exemplary profile and four exemplary preference sets created from one PSS;

FIG. 5 is a flow diagram showing a first illustrated embodiment of a process 100 of system 10 for retrieving matchable entities corresponding to a selected preference set;

FIG. 5A is a schema diagram showing how matches are determined in an exemplary implementation of process 100;

FIG. 5B is a schema diagram showing how matches are determined in an exemplary implementation of process 100B, a modification of process 100;

FIG. 5C is a schema diagram showing how matches are determined in an exemplary implementation of process 100B_0, a modification of process 100;

FIG. 5D is a schema diagram showing how matches are determined in an exemplary implementation of process 100B_1, a modification of process 100;

FIG. 6 is a flow diagram showing a first illustrated embodiment of a process 200 of system 10 for retrieving summary statistics pertaining to at least one preference set;

FIG. 6A is a schema diagram showing how a first exemplary embodiment of a user dashboard, which enables a user to access their preference sets, may be implemented on a device of an entity;

FIG. 6B is a user graphical interface display showing how a second exemplary embodiment of a user dashboard, which enables a user to access their preference sets, may be implemented on a device of an entity;

FIG. 7 is a flow diagram showing a first illustrated embodiment of a process 300 of system 10 for determining personas of a second matchable entity from the perspective of a first matchable entity;

FIG. 7A illustrates an exemplary graphical user interface profile page, wherein a dashboard displays the personas of a second matchable entity from the perspective of a first matchable entity; and

FIG. 8 is a flow diagram showing an exemplary user workflow of a process 400 of system 10.

### DETAILED DESCRIPTION

Modern dating websites, mobile dating applications, social networking websites, employment websites, professional websites, internet-facilitated communication and/or networking platforms, systems, applications, and the like, have been around for approximately three decades, providing users across the globe another way to find and connect with potential love interests, potential acquaintances, potential business connections, potential employees, etc. While these systems have produced successful outcomes, they are slow, tedious, inflexible, and limiting to use.

An embodiment of the present disclosure enables at least one matchable user or entity of a system to create a plurality of possibly related preference sets, thereby enabling the at least one matchable user or entity to match, by orders of magnitude, more efficiently and user-friendly with the multitude of possibly disparate, compromised, and/or desired other matchable users or entities of mutual interest or like-mindedness within the system.

In social and matchmaking platforms, an entity's profile generally informs the platform's system and other entities of who or what the entity is (e.g., the traits or photos of a single person looking for a romantic partner, the parameters of a job opening or posting looking to be filled by a person, etc.), while the entity's preference set informs the system of whom or what the entity is seeking or compatible to match with (i. e, the parameters describing a subset of the other matchable entities of the system).

A common element of a preference set of many existing matchmaking platforms is a filter. When expressed in English, an exemplary filter may translate to “a match must be less than 10 miles away”. A common consequence of allowing only one preference set per user is the scarcity of filters made available to the users.

There appears to be a negative correlation between the number of filters and the number of active users on a platform (i.e., the less filters the more users). As of this filing, the leading dating app on the market by user count allows its free users only three filters: gender, age, and distance. Filters are risky because they may lead to zero or not enough matches. From the perspective of a matchmaking service's viability as a business, few things are worse than returning an empty list to a customer.

However, filters may have a positive correlation with quality and efficiency. The more filters in a user's preference set, the higher the quality of the user's matches, and the less work the user needs to do, because the filters enable the system to do the work for the user.

The concept of a “preference set” isn't standard in the existing platforms, let alone “one preference set”, as the term “set” may already imply a discrete unit that could serve as a catalyst for more than one unit. In the lingo or jargon used in the existing matchmaking online marketplace, a user's intentions, desires, preferences, filters, goals, and/or the like are collectively and commonly referred to as “the user's preferences”.

A preference set is a difference between a matchable entity and a browsable entity. Examples of browsable entities include products available for purchase on an e-commerce website. A browsable entity may also have a profile comprising parameters or traits that describe it to the system and browsing entities of such website. However, unlike a matchable entity, a browsable entity does not discriminate, i.e., a browsable entity does not comprise any preference sets. Browsable entities are akin to items or information that exist to be searched by browsing entities, with intent or purpose solely on the side of the browsing entities. On the other hand, matchable entities embody intent and purpose in their matching.

The embodiments of the present disclosure relate to a system and methods that facilitate discovery (i.e., matching) between matchable entities using primarily profiles and preference sets associated with said matchable entities. However, this should not be viewed as limiting embodiments described herein from being modified to also include browsable entities. For example only, a romance matching website or dating app may also incorporate merchandises, or other types of browsable entities, that its matchable users can search for and purchase or gift.

In the teachings herein, many of the examples involve the use of filters in preference sets. This is simply based on the assumption that filters are easy to explain and understand. However, it should be appreciated that filters are merely one possible or optional element of a preference set, commonly implemented in existing dating or romance matchmaking platforms, and are not required.

In many of the examples of the teachings herein, a matchable entity is merely a user of the system, and so terms like “matchable entity”, “matchable user”, “entity”, “user” or “matchable entity or user” may be used interchangeably. In general, the teachings herein commonly refer to an agent or owner (i.e., a user) being associated with and/or performing functions on behalf of a matchable entity, even when the matchable entity is the user itself.

However, it should be noted that in some embodiments of the present disclosure a matchable entity may not necessarily be a user or a person, as in the case of a job opening or posting seeking to match with job seekers. Just as a job seeker (i.e., a person) may prefer certain jobs over others, a job opening or posting may also prefer certain employees over others. In other words, entities representing non-humans can also have preference sets (i.e., discriminate), along with profiles, and thus can also be matchable entities.

With advances in artificial intelligence, an agent or owner (i.e., a user) of a matchable entity also need not be a human. For example only, an embodiment may be modified to allow AI agents or users to manage a set of matchable entities that represent job openings or postings.

The disclosure herein includes exemplary embodiments of processes for determining matches based on a matchable entity's preference set. A match for a first matchable entity generally refers to another matchable entity that corresponds to, i.e., matches, a preference set associated with the first matchable entity and is transmitted to a device associated with the first matchable entity.

A matchable entity may be determined to pass a preference set, which is one criterion, among possibly others, for determining whether the matchable entity corresponds to the preference set. A preference set may include at least one explicit matching context, such as an intention or a relationship goal. A matchable entity passing a preference set generally refers to it matching the preference set without considering matching contexts. A matchable entity may also be described as passing aspects of a preference set, such as a distance filter specified within the preference set.

A matching context, such as an intention or a relationship goal, specified in a preference set may serve to inform other matchable entities. In some existing platforms and embodiments of the present disclosure, a matching context specified in a preference set is utilized by the system to further refine matches. Various methods and processes have been implemented in existing platforms for determining whether the matching contexts of the preference sets of two matchable entities equal, overlap, and/or are compatible, which may serve as an additional criterion for determining correspondence between these two matchable entities, in accordance with certain teachings herein.

A matching context may also be derived implicitly from the mission or policy of a platform itself. For example only, many existing matchmaking platforms specialize in matching users for “dating”. In these platforms, there may not be any explicit matching context implemented in data or code. However, it is evident to the users of such platforms, based on their advertised mission, that the intent, goal, or purpose of matching is “dating”.

In the teachings herein, the term “implicit” generally refers to concepts or objects that are not explicitly present in data but are interpreted or derived through rules, policies, or similar mechanisms.

Various matchmaking methods and processes have been implemented by existing matchmaking platforms for determining whether a matchable entity passes or corresponds to another matchable entity's preference set. The most common and simplest among them may be the implementation of filters in preference sets, which specify required conditions that a matchable entity's profile or other aspects must meet.

Beyond the preference set of a matchable entity, various existing platforms and embodiments of the present disclosure may also consider the profile and/or other data associated with the matchable entity as additional criteria for determining matches for the matchable entity, in accordance with certain teachings herein.

In some embodiments described herein, a match may also refer, in the colloquial sense, to a pair of matchable entities that are matched. Further, a match may not be mutual in that, if a first matchable entity corresponds to a preference set associated with a second matchable entity, the second matchable entity may not necessarily correspond to any preference set associated with the first matchable entity.

It will be apparent to one skilled in the art that practicing the teachings herein is neither dependent on nor limited to any specific matchmaking method or process for determining matches corresponding to a user's preference set.

In the teachings herein, two preference sets are related if a match corresponding to one can serve as a substitute or compromise for a match in the other. For example only, two preference sets, each with a matching context of “dating”, are related. In another example, a preference set with a matching context of “dating” is also related to another preference set with a matching context of “marriage”, as both are related to seeking romantic partners. Many people who have not yet met the right match to marry often make a short-term compromise and match with someone else for dating.

While the present disclosure primarily discusses preference sets related to romance, preference sets related to other contexts are also addressed. Some embodiments of the present disclosure may also allow matchable entities to have unrelated preference sets, such as those with a matching context of “dating” and others with a matching context of “friendship”.

Having the ability to create a plurality of possibly related preference sets may allow a user to both compromise and be perfectionist. For example only, if a user can create ten preference sets, each representing a point on a spectrum of acceptable matches for a potential romantic partner, then the user is able to simultaneously wait for the “Mr Perfect” to arrive someday and settle for an “Ordinary Joe” for the user's next date.

The combination of these ten related, but independent and discrete, exemplary preference sets gives a platform more leeway to make available more filters to their users. If the preference set for “Mr Perfect” (due to having too many and/or overly strict filters) were to yield zero matches, the preference set for “Ordinary Joe” may yield enough matches to retain the user instead of driving them to churn to another platform.

The ability of a user to create a plurality of possibly related preference sets, therefore, may make a platform more durable. A durable platform in turn may have the leeway to give their users more filters, leading to even more quality and efficiency than just having a plurality of related preference sets brings alone.

But, limited availability of filters is just one example of a broader issue, which is that the rigorousness of the matching process of a platform is generally negatively correlated with the number of users on the platform.

For instance, beyond limited filters, the filtering process, which is part of the overall matching process, of the most popular platform as of this filing is not even mutual. In other words, the platform's system retrieves matches for a user based on the user's filters but does not account for whether the user satisfies the filters of those matches.

In order for a matchmaking platform to work at all, it may need to reach a certain threshold of users (i.e., a critical mass), hence forcing it to limit the number of filters and ultimately to reduce matching rigorousness.

Thus, the ability for a user to create a plurality of related preference sets may be a key missing piece to solving the bigger puzzle of how to reverse the negative correlation between rigorousness in matching and number of users on a platform. The gold standard for a matchmaking platform may be a combination of a critical mass of users coupled with a rigorous matching process.

For contrast, the problem of balancing (i.e., trading off between) a rigorous search process and retaining a critical mass of users does not arise on platforms where browsing entities search for browsable entities. A browsing entity is not trying to find the “best” browsable entity; rather, it is seeking a specific browsable entity with certain traits or parameters. However, a matchable entity, especially in the context of romance, can be assumed to be trying to match with the “best” possible other matchable entity on the platform, which is inherently scarce. This scarcity, in turn, may drive many users to leave for other platforms (i.e., churn) with more lax matching processes that generate more matches, albeit of lower quality.

A romance matchmaking platform with an efficient system and an adequate number of filter or preference options may be able to attract the three golden demographics: women, students (i.e., young people), and attractive people. Attracting women to a platform may consequently attract men to the platform as well. Attracting students (i.e., young people) to a platform may secure the platform's future and longevity. Attracting attractive people to a platform may attract everybody else to the platform.

The female gender may be the more discerning or selective gender in nature. Students may have less need for matchmaking platforms to find romance, as they may be surrounded by like-minded peers just a dormitory away. Attractive people are looking to match with other attractive people, as are most people.

The key to addressing the challenges faced by these three golden demographics in the matchmaking marketplace may be an efficient system with sufficient filters. Filters allow women and attractive people to efficiently match with their select others. Filters also allow students to match with individuals outside their immediate social circle who may possess distinct traits compared to those within, thereby enticing students to use the platform of such system as an additional tool in their search for connections.

But even if a platform did provide sufficient filters for a user to create their perfect romantic match, with just one preference set the platform will most likely still fail to make this match. Once the platform informs the user that their preference set resulted in zero matches, at least for the moment, the user has two options: either leave the platform for another one (i.e., churn) or relax or remove some of the filters in their one preference set (i.e., to compromise as there is no guarantee that this match even exists, and adopting a wait-and-see strategy could result in zero matches for life). Assuming that the user relaxes or removes some of their filters, the user will then be spammed with subpar matches. However, if the user's perfect match were to register for the platform a week later, the user will most likely miss out on them as it is now equivalent to finding a needle in a haystack.

But if the user has the ability to create a plurality of preference sets relating to romance, this problem may be solved. The user can reserve a first preference set for their perfect match and wait as long as they need to for this match to show up someday. In the meanwhile, the user will create other preference sets comprising relaxed requirements, urgency, and commitment levels so that the user can meet someone just good enough for their next date. If this user's perfect match were to arrive on the platform a week, a month, or a year later, discovery between the user and their perfect match may be inevitable and almost immediate due to the existence of the first preference set. In other words, having a plurality of related preference sets allows a user to have their cake and eat it too, to have it both ways, or to even have it multiple ways.

In the search for a romantic partner, gender is perhaps the only non-negotiable filter quality. In reality, almost every other filter quality is fluid and depends on some other filter quality. Many people have a filter requirement for height, for example. But the height filter is created with the expectation that one's match would not be a billionaire. Otherwise, the height filter may be tossed immediately. This is a problem for platforms with one preference set per user for all related intentions. Most users would use their one preference set to specify a match with qualities that are predicated on other qualities being realistic (i.e., a well-rounded individual).

This problem may be solved in a platform where a user can create a plurality of preference sets comprising related intentions. Such user will create multiple preference sets where each may be based on different assumptions. One out of the many preference sets of such user may be reserved to specify an outlier individual represented by only one filter quality: net worth greater than or equal to one billion. Such user would not miss out on matching with the billionaire who may be one or two inches short of one's height “requirement”, while at the same time still having a decent chance to match with a more realistic and well-rounded individual, due to the other existing and related preference sets that this user will have created.

A person or entity could come in different forms. For example only, if a user is trying their luck to match with a “rich” romantic partner, they might filter based on income, net worth, expected inheritance, or education level. For this user, “rich” might mean just having at least one of these qualities: high income, high net worth, high expected inheritance, or advance degrees. With just one preference set, a user has to pick one out of the four qualities to filter by, thereby missing out on potential true positives possessing only the other qualities. Filtering using two, three, or all four qualities creates an even more restrictive preference set, thereby filtering out even more true positives. With a plurality of related preference sets, this problem may be solved. This user can create fifteen or more preference sets with romance-related intentions to cover all combinations of these four qualities.

In many, and possibly the majority of, existing romance matchmaking platforms, or dedicated romance modes within such platforms, enabling a user to specify their matching intentions has become an established feature. Exemplary matching intentions or contexts are “causal dating”, “serious dating”, “short-term dating”, “long-term dating”, etc. In many such platforms, a user may be permitted to select more than one matching intention from a predefined list. However, all selected matching intentions are part of the same preference set, as the user is limited to only a single preference set. This is a clear problem as many people may prefer different qualities in matches depending on the specific romance matching context or intention.

Many users may be open to both “casual dating” and “serious dating” simultaneously, and a match in one may indeed be a substitute or compromise for a match in the other. But, when seeking a partner for “casual dating”, for example, a user may filter based on physical appearance, while they may filter based on income when seeking a partner for “serious dating”. Hence, fitting multiple intentions into a single preference set is erroneous, ineffective, slow, tedious, inflexible, and limiting for at least a non-trivial number of users and scenarios.

Some embodiments of the present disclosure reverse this restriction by enabling a user to be associated with multiple preference sets per intention, while other embodiments enable a user to be associated with multiple preference sets for all supported romance-related intentions.

The current online romance matchmaking marketplace is saturated with hundreds, if not thousands, of niche websites and mobile apps. A typical user seeking romance often uses several of these websites or mobile apps within a given period. User burnout is reported to be on the rise.

Many existing romance matchmaking platforms specialize in demographic niches. For instance, a platform could specialize in people who are sober, another in people who are Christian, another in people who watch Japanese anime, another in people who are looking for marriage, another in people of certain ethnicities, etc.

By enabling a user to create a plurality of related preference sets, and thereby enabling a platform itself to be durable enough to allow more filter or preference choices to its users, one platform could specialize in multiple such demographic niches. A user of such platform may then create multiple discrete preference sets targeting each of the listed demographic niches, either individually or in combination. In other words, a preference set could be construed as a specialized niche.

It should be appreciated that a platform specializing in multiple niches, by enabling multiple related preference sets, is not general-purpose; instead, such platform can be construed as being all-purpose. In a truly general-purpose matchmaking platform, confusion may arise among matched users, leading to a degradation in quality and an increase in false positives, ultimately compelling the platform to specialize.

Unlike actual niche platforms, which are each limited in variety and dept, the user can easily combine the multitude of filters of a durable platform to create ultra-customized niches (i.e., preference sets). For example only, a user can easily create a preference set to target the ultra-customized niche of people who are sober, Christian, consumers of Japanese anime, looking for marriage, and of certain ethnicities. Such an ultra-customized niche generally does not have enough users to warrant the efforts or costs of creating an entirely separate platform. But the effort to create such a niche, for a user, in the form of a preference set within an already existing platform is minimal. Likewise, the efforts and costs for the stakeholders and developers of a platform, should they decide to add more filters in recognition of previously unrecognized niches, could be significantly less than creating an entirely new platform.

It should also be appreciated that a user is likely to create such an ultra-narrow preference set, which would most likely yield zero matches, only if they also can create other related preference sets, representing compromises or substitutes. Likewise, only a durable platform, which enables its users to create a plurality of possibility related preference sets, is likely to enable such an ultra-narrow combination of filters, as its users may have other related preference sets with relaxed filters that yield enough matches to prevent them from churning to other platforms.

Niche platforms are also inflexible in that they only match people of similar ilk (i.e., people belonging to the same niche). In an exemplary Christian dating platform, it is assumed that all users will be Christian, or at least that is the intent or ideal. However, it is possible that someone who identifies as Christian may not necessarily require their match to also be Christian, as long as the match possesses other desirable qualities. In contrast, someone who is not Christian but is sober and looking for marriage may intentionally want to match with a Christian. There is no niche platform that specializes in this kind of diverse pairing, and this sober, non-Christian user would ideally be rejected from joining the Christian platform. In other, less specialized platforms that enable a single preference set per user, this pairing is also unlikely, as the Christian user will most likely have religion (“Christian”) as a filter in their preference set.

But if a platform enables multiple related preference sets per user, the sober user will not be rejected from joining, and the Christian user has the flexibility to compromise by creating other related preference sets without a filter for religion, thereby enabling the diverse pairing of the Christian user with the user who is not Christian but is sober and seeking marriage.

The most popular existing romance matching platforms specialize in the most in-demand relationship goal or matching context as a niche: “dating” (as opposed to “marriage”, etc.). Within these platforms, a user may even have the option to further clarify their intent by selecting one or more sub-goals, such as “long-term dating”, “short-term dating”, “hookups”, and/or the like. Despite already narrowing down to a specific niche, these platforms still struggle with identity, as they are stigmatized for primarily matching people for “hookups”. This reputation may deter potential users seeking more serious dating, even though these platforms may support that as well. These platforms'users also struggle to guess their matches'true intentions. Even after two users have matched, it may not be clear to either what the other's true intent is.

The problem of establishing a clear reputation and identity for a platform becomes more challenging the more niches it attempts to support. This is why no popular platform successfully supports niches like “dating”, “marriage”, and “sugar dating” within the same platform, despite all of these being related to romance.

In some embodiments described herein, users have the option to add an explicit matching context, such as an intention or a relationship goal, to a preference set. In some of such embodiments, matching requires the matching contexts of preference sets to equal, overlap, and/or be compatible, as one of potentially several conditions, in order for the users associated with the respective preference sets to match. For example only, a user can create one or more preference sets each for “long-term dating”, one or more preference sets each for “short-term dating”, one or more preference sets each for “hookups”, one or more preference sets each for “marriage”, one or more preference sets each for “sugar dating”, and/or the like, thereby clearly partitioning their goals and intentions into separate, manageable silos. If a user matches with another user through one of their hyper-specialized preference sets with the relationship goal of “long-term dating”, for example, the user and its match will have little doubt about the other's true intentions.

When the users of a platform are not confused about their matches' intentions, the users may stop unfairly or mistakenly stigmatizing or pigeonholing the platform into any one type, especially when the platform supports pairings of multiple types.

Other existing primarily romance matchmaking platforms attempt to match users beyond romance. Some of such platforms are partitioned into separate and predefined modes, which are separate environments within the platform. For example only, a platform that is primarily intended to match users for dating may also have separate social modes that match users for friendship, business networking, etc. A user can switch between these modes depending on who or what the user is looking to match with at the moment.

These multi-mode platforms are essentially an attempt to linearly combine multiple disparate niches of matchmaking platforms into one, yielding a predictable and linear outcome. Indeed, the reverse has also been done, where one of the modes of a larger platform containing multiple modes has been extracted from said larger platform and made into its own standalone platform.

These multi-mode platforms are limited in the same way, as they may provide at most one preference set per mode per user. However, each of these multi-mode platforms comprise modes that are unrelated in terms of matching context or intention. For example, a mode for dating is unrelated to modes for friendship or business networking in that a match in one cannot be viewed as a substitute or compromise for a match in the others, and vice versa. Therefore, the preference set of one mode is also unrelated to the preference set of another mode in these multi-mode platforms.

A platform or system that is not partitioned into modes or environments can be construed as comprising one mode or environment.

There are still other existing platforms that take a user's single preference set and generate multiple distinct lists of matches, each emphasizing different aspects of compatibility or incorporating varying structure or stipulations for engagement or interaction with matches. These distinct lists are commonly referred to as modes as well, but may also be referred to as spaces, rooms, or groups, which can also be construed as separate environments. On the user's device interface, the user may toggle or switch between these modes or spaces to explore matches generated from different matchmaking processes using the user's single preference set.

Some common modes of these platforms include “passport”, “recommended”, “suggested”, “discovery”, “compatibility”, etc. Some common spaces of these platforms include “foodie”, “gamer”, “movies”, etc. The “passport” mode, in effect, allows a user to temporarily edit their profile location to match with users in other parts of the world.

Some of these platforms may allow a user to make temporary edits to their single preference set, similar to temporary profile edits. For example, an existing romance platform generates two distinct lists of matches, called “Suggested” and “Discover”, based on the user's single preference set that is stored on the server side of the system. These lists are generated periodically once per day. After receiving these lists on the user's device, the user can make temporary edits to their single preference set to request for additional matches beyond the day's batch in the “Discover” mode corresponding to the temporary edits. These temporary edits persist only on the user's device and only for the duration of the user's session (i.e., until the user closes the platform's client application, e.g., on their mobile device or web browser, or logs out), and the next day's batch is generated based on the user's single preference set and profile that are stored on the server side of the system.

Some of the previously discussed problems could, in theory, still be solved by having just one preference set; however, in practical term, they may not. To solve the problem of a user missing out on their perfect match after relaxing the filters in their one preference set, for example, the user would have to constantly tweak (i.e., edit temporarily or persistently) the filters in their one preference set back and forth, regardless of the mode or space they are in or switch to. This would be the epitome of slow, tedious, inflexible, and limiting. Most users do not have the patience to do this. Most users wouldn't even think of doing this to begin with.

In some embodiments described herein, a user has access to a dashboard that displays the user's preference sets. Upon visiting this dashboard on the user's device, the system will search for matches corresponding to each of the user's preference sets in parallel and transmit summary statistics to the user's device. With these summary statistics, such as the count of matches corresponding to preference sets, clearly displayed, the user can focus their search on preference sets that yield positive match counts, tighten filters of preference sets with excessively high match counts, relax filters of preference sets with low match counts, and/or perform similar actions. The time and effort required for a user to create a preference set is infinitesimal compared to the time and effort required for a development team to create a new platform.

Some other problems simply cannot be solved with one preference set. In some embodiments of the present disclosure where the matching process is double-sided or mutual, requiring both entities to pass at least one of each other's preference sets, two entities that would not have been a match when each has only one preference set may be a match when at least one of them has multiple preference sets. For example, if a first user has one preference set that contains a filter that requires another user's height to be at least six feet tall, then this first user would not be a match to a second user whose height is less than six feet tall regardless of what the second user does with their one preference set as the second user's profile cannot get pass the height requirement of the first user's one preference set. However, if the first user has a second preference set that does not contain a height filter, then the second user may encounter the first user as a match if the second user can get pass the first user's second preference set. In other words, having a plurality of preference sets increases the odds of true positives matching with one another compared to having only a single preference set.

Enabling a plurality of related preference sets within a single platform is comparable to the analogy that “the whole is greater than the some of its parts”. For example, when a user opens their smartphone, they may be presented with the icons, all on the same screen, for ten mobile apps or platforms that are related to romance matchmaking that this user is a member of. This, in effect, is a makeshift way to give the user access to ten preference sets related to romance, all just a tap away. But, because these ten preference sets are split across ten separate platforms, it doesn't have the side effect of enabling any one platform to be more durable. Each of these ten exemplary platforms, if they aim to be popular and retain many users, is discouraged from implementing a rigorous matching process, fearing that doing so may result in not being able to provide enough matches to their users, which could cause users to churn to the other platforms. However, a durable platform that enables a plurality of related preference sets, allowing their users to compromise, doesn't care if a user “churns” from one preference set to another.

Furthermore, even if these ten exemplary platforms together have millions of users, those users are split across the separate platforms. The preference set of any one of these ten exemplary platforms cannot reach the majority of those millions of users, who are located on the other nine platforms. Even though this particular exemplary user is a member of all ten of the platforms, it is highly unlikely that even a small minority of those millions of users are also members of all ten.

However, as discussed earlier, by allowing users to partition their various co-existing intentions into separate preference sets and thereby removing confusion, a platform that enables a plurality of romance-related preference sets may solve the identity issue, avoiding stigmatization or pigeonholing. In doing so, such platform may be able to attract and retain those millions of users that are split across those ten exemplary platforms, unifying them all under one platform. In this scenario, any one of a user's preference sets can reach all those millions of users.

Furthermore, this user would need to search or query these ten exemplary platforms separately one at a time, only to receive low-quality matches generated from non-rigorous or superficial matching processes. In some embodiments described herein, this user would instead just need to perform a single action: visiting their dashboard. Upon doing so, matches for all ten of their preference sets, the equivalences of the ten exemplary platforms, would be searched simultaneously in parallel. This search request may also retrieve summary statistics and sort the preference sets accordingly, enabling the user to discover and focus their effort on who is available at the moment. In addition, a durable platform implementing such embodiments may have the leeway to incorporate a rigorous matching process, improving match quality and enabling even greater efficiency beyond just the parallel search.

In some embodiments of the present disclosure, the improved efficiency from the parallel search for this exemplary user, with one hundred equivalent preference sets instead of ten, would be one hundred times greater instead of ten, compared to the makeshift way.

Furthermore, a single platform that enables a user to create one hundred romance-related preference sets, requiring only a single registration and profile setup, will save this exemplary user the time and effort of registering for the one hundred makeshift platforms and setting up one hundred profiles, which would largely contain duplicate information.

While the system and methods of the present disclosure are described primarily in relation to an online romance matchmaking platform, it should be appreciated that the system and methods of the present disclosure can be used on any platform that facilitates matches sought by its entities, whether they be romantic matches (i.e., an online dating website and/or mobile application), employment matches, professional matches, recruiting matches, real estate matches, non-romantic personal matches, and/or the like. Further, although the system and methods of the present disclosure are described in connection with the exemplary illustrated embodiments, they are not intended to be limited to the specific forms set forth herein. On the contrary, they are intended to cover such alternatives, modifications, and equivalents as can be reasonably included within the spirit and scope of the present disclosure as defined by the appended claims.

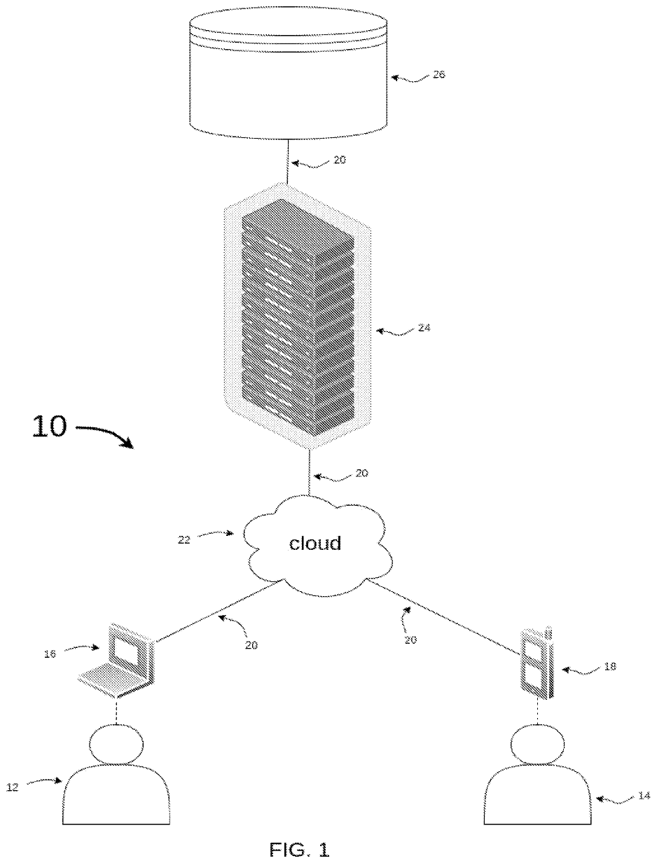

FIG. 1 illustrates a field implementation of a first illustrated embodiment of an exemplary system for entity matching, system 10, in which aspects of the disclosure can be implemented. System 10 primarily facilitates romantic connections, in this exemplary illustrated implementation, between a plurality of users (i.e., the matchable entities) of system 10. The system 10 further comprises, associated with the plurality of users, a plurality of electronic devices, profiles and preference sets. System 10 stores the plurality of profiles and preference sets in at least one database (database 26) associated with at least one physical and/or virtual server (server 24) of the system 10. In a modified or alternative embodiment, system 10 may instead store the plurality of preference sets locally in the non-transitory memory of the plurality of electronic devices. Users interact with the system 10 by forming a network connection 20 with the server 24 associated with the system 10. For example, a first user 12 of the system 10 may access server 24 by connecting a computer, mobile phone, and/or an electronic communications device 16 to a network, such as cloud 22 in this exemplary illustrated implementation, via a wired and/or wireless data link, such as network connection 20. The wired and/or wireless data links can include any one of or combination of discrete signal inputs, standard or proprietary Ethernet, serial connections, wireless connections, and/or any other means of connecting to the server 24.

Once connected, the first user 12 can request that the system 10 perform a search in database 26 associated with server 24 for matchable entities corresponding to a first preference set. Server 24 performs the requested search against the first preference set in database 26. The matchable entities identified by server 24 are transmitted electronically to the first user's 12 device 16 through the cloud 22 via a wired or wireless data link, such as network connection 20. The first user's 12 electronic communications device 16 and the server 24 can communicate over a variety of wire or wireless communications links, such as Wi-Fi, cellular, satellite, private wireless systems, and so on. Data link 20 can be, for example, a wireless local area network (WLAN), wireless metropolitan area network (WMAN), wireless wide area network (WWAN), a private wireless system, a cellular telephone network or any other means of transferring data from the server 24 to the first user's 12 device 16, and vice versa. The first user's 12 device 16 receives the matchable entities transmitted by server 24; the first user 12 may then encounter one of interest associated with a second user 14. The first user's 12 device 16 can then request server 24 for engagement with the second user 14. System 10 may then facilitate engagement between device 16 of the first user 12 and device 18 of the second user 14.

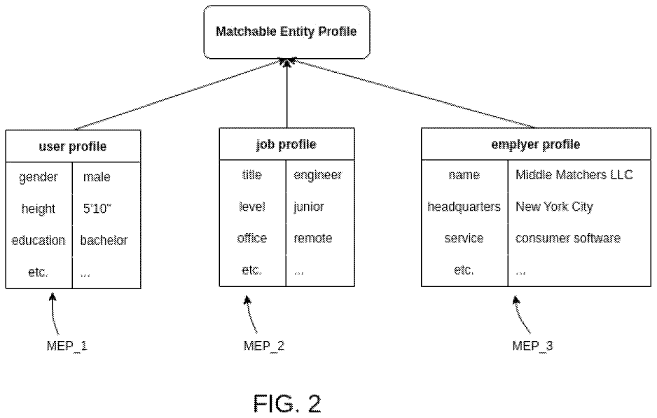

FIG. 2 is a schema diagram showing three illustrated embodiments of matchable entity profiles. The matchable entity profile to the left shows an exemplary schema of a user profile MEP_1. The combination of the parameters of gender, height, and education level indicates that this user profile most likely belongs to a system that matches users primarily for romantic connections, such as system 10. The matchable entity profile in the middle shows an exemplary schema of a job profile MEP_2. A system that comprises job profiles likely matches job seekers with job openings or postings. The matchable entity profile to the right shows an exemplary schema of an employer profile MEP_3. The system that comprises job profiles likely also comprises employer profiles. This system could also be matching employers with job seekers directly. A matchable entity may be under the account of a larger entity; in this case, job entities are likely under the accounts of employer entities which created and own the job entities.

Part or all of the parameters of a matchable entity's profile may be used as part of the input to system 10's matchmaking processes for determining if the matchable entity is a match to other matchable entities, and vice versa.

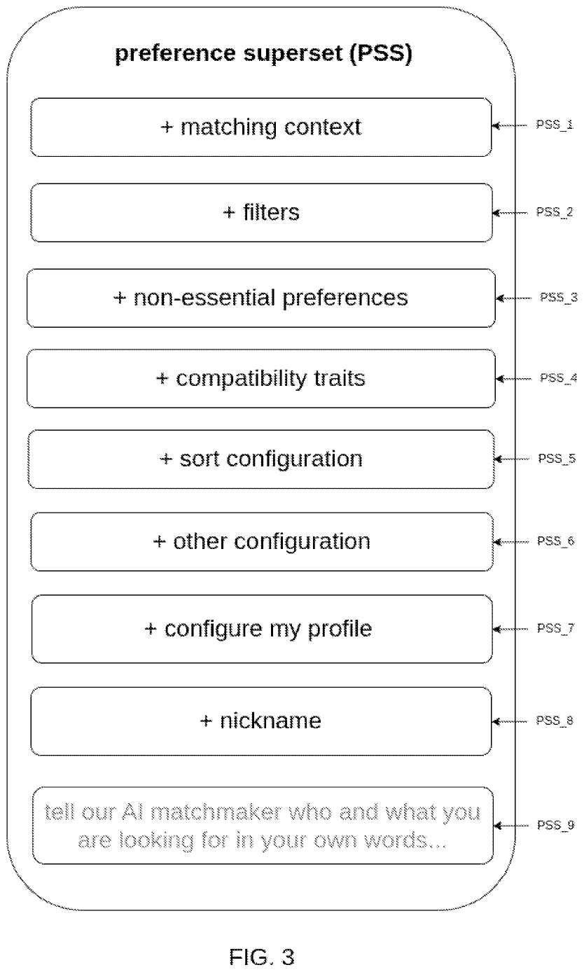

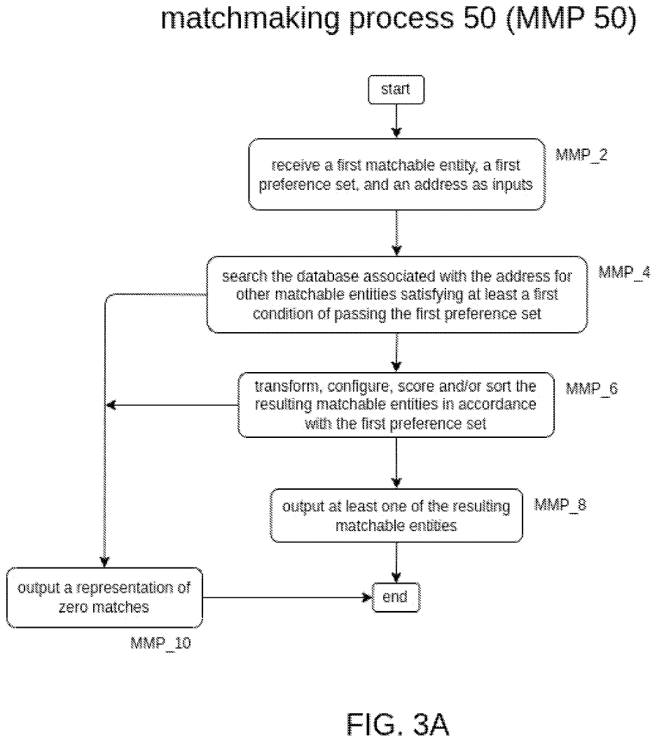

FIG. 3 is an interactive graphical user interface screen diagram showing an illustrated exemplary embodiment of a preference superset (PSS) template of system 10. A PSS contains possible data that a user of a matchable entity can input to system 10 to describe whom or what the matchable entity seeks to match with. A PSS template is used by the user, via a device associated with the user, to create individual preference sets, for the matchable entity, that conform to the PSS of the template.

System 10 may also impose specific structure, stipulations, criteria, configuration, and/or the like on the matches corresponding to preference sets from a specific PSS. For example, and for illustration purposes only, matches corresponding to preference sets from one PSS may require payment in order to engage with, while matches corresponding to preference sets from another PSS may be free to engage with.

Another exemplary stipulation could involve generating matches for preference sets created from a particular PSS only on specific days of the week. Such an embodiment may, for example, provide users with seven PSS, one for each day of the week.

Server 24 of system 10 may use different matchmaking processes to determine matches corresponding to preference sets from one PSS compared to those from another PSS. System 10 may use multiple matchmaking processes to determine multiple distinct lists of matches corresponding to the same preference set. For example only, system 10 may use a first matchmaking process, a second matchmaking process, and a third matchmaking process, each taking a first preference set as input, to determine a first list, a second list, and a third list of matches corresponding to the first preference set, emphasizing compatibility, physical attraction, and serendipity, respectively, after applying any filters of the first preference set. The first list, second list, and third list are then available to be retrieved by the user of the matchable entity associated with the first preference set via their device and cloud 22.

Within system 10, each preference set is a subset of the PSS from which the preference set is created and, therefore, conforms to the input format (i.e., data format) of that PSS. Each preference set represents a unit of data, among others, that system 10 may use as input to determine matches among matchable entities stored in database 26. Server 24 of system 10 may be adapted to validate preference sets according to the rules and requirements of the PSS to which the preference set is claiming conformity. If system 10 comprises more than one PSS, it may logically associate a preference set in memory with the PSS from which the preference set is created.

For example only, an exemplary PSS, with an implicit matching context (“dating”) derived from the platform's specialization or mission, may consist of three configurable filters: gender (with three options: “male”, “female”, and “non-binary”), age (with a range from 18 to 100), and distance (in miles, with a range from 1 to 100). An exemplary preference set, which conforms to this exemplary PSS, may consist of filters for gender (“male”) and distance (1 to 20). Yet another exemplary preference set conforming to this exemplary PSS may consist of a filter for gender (“female” or “non-binary”). Both the exemplary preference sets implicitly inherit the matching context (“dating”) from this PSS, and are therefore related. Since the matching context is implicit and cannot be edited, all preference sets created from this exemplary PSS are related to “dating”.

This exemplary PSS can be construed as allowing a finite number of combinations of inputs. But, as will be discussed later, a PSS may comprise unstructured inputs, such as freeform text entered by a user, which may be processed by an artificial intelligence model to determine matches. Thus, a PSS may also be, in practical terms, unbounded in the possible combinations of inputs it allows.

In some embodiments, system 10 enables each matchable entity access to at least one PSS for creating at least one preference set, while also enabling at least one matchable entity access to at least one PSS that provides the additional privilege of creating a plurality of preference sets.

A matchable entity may be permitted to create an empty preference set, which may be interpreted as a non-discriminating preference set by system 10, as such preference set includes no inputs from the entity. An empty preference set of a matchable entity may be distinguished from a situation where the matchable entity has no preference sets created; system 10 may permit a matchable entity to abstain from creating any preference sets.

System 10 may also be adapted to treat this situation as if the matchable entity has a single implicit preference set that is empty (i.e., non-discriminating) and no other preference sets, or may be adapted to treat this situation as an indication that the matchable entity is not seeking matches at the moment. The situation of a matchable entity not having created any preference sets may occur commonly during the initial stages after account registration, or when the matchable entity has deleted all of its preference sets.

Once a preference set is created, the user may be able to edit, delete, suspend, deactivate the preference set, and/or perform similar functions. System 10 may monitor the creation process of a preference set from a PSS to prevent such things as duplicate preference sets associated with the same entity, too many preference sets associated with the the same entity, ineffective preference sets, and/or the like.

A first exemplary PSS may enable a matchable entity to create subsequent preference sets from the same input options as their previously created and existing preference sets, thereby allowing the creation of possibly duplicate preference sets that exist simultaneously for this matchable entity. System 10 may be adapted to monitor this process so as to reject duplicate preference sets associated with the same matchable entity.

A second exemplary PSS may enable a matchable entity to create subsequent preference sets that can specify a matching context from the same list of options as their previously created and existing preference sets, thereby allowing the creation of preference sets that exist simultaneously with identical matching contexts for this matchable entity. If the matching context of a PSS is fixed and/or implicit, this condition is automatically satisfied. For example, a platform specializing exclusively in matching users for dating may be construed as having a fixed and/or implicit matching context of “dating” applied to every preference set.

A third exemplary PSS may enable a matchable entity to create preference sets that can specify an unstructured, freeform matching context, such as text input provided by the matchable entity, thereby allowing the creation of preference sets that exist simultaneously with identical matching contexts for this matchable entity.

A fourth exemplary PSS may enable a matchable entity to create subsequent preference sets that can specify a matching context from a list of options related to the matching contexts of their previously created and existing preference sets, thereby allowing the creation of preference sets that exist simultaneously with related matching contexts for this matchable entity. For example only, a PSS may enable a matchable entity to create one preference set for each of the following matching contexts: “short-term dating”, “long-term dating”, “marriage”, and “friendship”. If the matchable entity creates the maximum of four preference sets from this PSS, they would have three preference sets existing simultaneously related to romance from this PSS.

The first exemplary PSS, second exemplary PSS, third exemplary PSS, and fourth exemplary PSS, equipped with the functionalities described above, each enable a matchable entity to create a plurality of related preference sets.

A plurality of preference sets created from a common PSS may not necessarily be related, but they should at least have the potential to be related. If two preference sets cannot be related, each should be construed as having been created from a different PSS. For example, in the platforms that are partitioned into separate matching modes, such as a dating mode and a friendship mode, the preference set within each mode cannot be related even if every explicit input option (e.g., filters) is identical, as the matching context of each is implicitly derived from the respective mode and cannot be edited. In addition, the list of matches corresponding to the preference set of each mode is most likely generated by a distinct matchmaking process specific to the respective mode. Thus, each of the two preference sets is created from the PSS of its respective mode, rather than from a common global PSS of the platform.

A plurality of related preference sets created from a common PSS should also have the potential to be distinct from one another. One way to achieve this is for the common PSS to, at a minimum, enable other data inputs (e.g., filters) that can vary among preference sets with equal or related matching contexts. These other data inputs, such as filters, should have the potential to influence the output of the matching process, including match ranking, filtering, etc. As a counterexample, if a PSS enables a matchable entity to specify a nickname for each preference set, solely to allow the matchable entity and/or system 10 to uniquely identify the preference set, this nickname input generally would not influence the matches generated from the preference set.

However, both the practicality for ensuring that preference sets associated with the same matchable entity are distinct, and methods for achieving this, will be apparent to one skilled in the art.

In some modified embodiments, system 10 is adapted to enable at least one matchable entity to create a plurality of distinct preference sets that are related in ways other than or beyond conforming to the same PSS. Other relations among the plurality of preference sets of the at least one matchable entity may include, but are not limited to, at least one of: all being associated with the same mode, all being associated with the same space, all being associated with the same environment, all comprising equal or related matching contexts, all comprising equal or related intentions, all comprising equal or related goals, all comprising equal or related purposes, all relating to seeking professional connections, all relating to seeking employment, all relating to seeking platonic companions, all relating to seeking romantic and/or sexual partners, and/or the like.

While seeking a friend, a romantic partner, and a business connection are clearly unrelated matching contexts or intentions, since a match in one cannot be a substitute or compromise for a match in the others, there may be other matching contexts or intentions that are related, even if they are not exactly equal.

For example only, the matching contexts of “dating”, “hookups”, “marriage”, “sugar dating”, “friends with benefits”, “soulmates”, and the like all fall under the category of romance and are thus related. If a user cannot find a compatible match to marry, they may make a short-term compromise by finding a match to date, and vice versa. System 10 may allocate a distinct PSS (e.g., having possibly distinct filters) for each of those romance matching contexts and limit a matchable entity to one preference set for each matching context or distinct PSS. In aggregate, such modification of system 10 would still have enabled a matchable entity to create a plurality of related preference sets. Thus, enabling a matchable user to create a plurality of preference sets related to the various romance intentions (instead of strictly conforming to the exact same PSS) exemplifies such a modification to system 10, which still provides for similar levels of enhancements to the experiences of a matchable user, making it more efficient and user-friendly compared to having only a single preference set related to seeking romance.

For example only, system 10 may be adapted to allocate a first exemplary PSS for dating and a second exemplary PSS for marriage. The first exemplary PSS and second exemplary PSS may each include some filter options that are not available in the other. Such a modification of system 10 operates under the reasonable assumption that the qualities someone seeks in a spouse may be different from the qualities someone seeks in a date.

Two preference sets are related if a match corresponding to one can serve as a substitute or compromise for the other. In the present disclosure, four categories of relations are explicitly recognized, but they should not be construed as limiting or exhaustive.

The first relation is matching for business, professional and/or career networking. A match corresponding to any preference set related to any variant of these intentions, goals, or purposes can serve to further a matchable entity's financial gains or work-related endeavors.

The second relation is matching for employment. A match corresponding to any preference set related to any variant of this intention, goal, or purpose can serve to secure a job for a seeker, and vice versa.

The third relation is matching for platonic companionship. A match corresponding to any preference set related to any variant of this intention, goal, or purpose can serve to expand a matchable entity's social, friendship, or emotional support circle. For example, a match corresponding to a first preference set, with a matching context (“weekend workout buddies”) and filters for gender (“male”), occupation (“student”), and diet (“vegan”), can be viewed as a compromise or substitute for a match corresponding to a second preference set, with a matching context of (“Wednesday movie night out”) and filters for gender (“female”), occupation (“hairstylist”), and diet (“keto”), as either match provides the desired emotional connection with another on a platonic level.

The fourth relation is matching for romantic and/or sexual companionship. A match corresponding to any preference set related to any variant of these intentions, goals, or purposes can serve to expand a matchable entity's circle of romance, love, or intimacy. For example, a match corresponding to a first preference set, with a matching context (“dating”) and filters for gender (“male”), occupation (“student”), and diet (“vegan”), can be viewed as a compromise or substitute for a match corresponding to a second preference set, with a matching context (“sugar dating”) and filters for gender (“male”), occupation (“CEO”), and income (at least $1M), as either match provides the desired intimate connection with another on a romantic and/or sexual level.

In some embodiments, a preference set may be implicit (i.e., it does not exist explicitly in data but is interpreted through rules, policies, etc.). For example only, a platform may specialize in matching male users with female users for heterosexual romantic relationships. Such platform may grant each of its female users the privilege to create a plurality of related preference sets targeting male users, but may not permit its male users to create any explicit preference sets at all. Even without any explicit preference sets, the system of such platform knows that all its male users are seeking to match with female users, as this is what the platform advertises and specializes in. Each male user of this platform can be construed as having one implicit preference set with an implicit filter for gender (“female”), thereby qualifying as a matchable entity. Such implicit preference set is enough information for such platform's system to determine matches for each of its male users. Alternatively, to further empower and/or protect the privacy of its female users, this platform may retrieve matches only for its female users, enabling only them to initial contact while revealing their presence or profile only to male users that they are interested in. Such platform operates under the assumption that heterosexual male users are entirely non-discriminatory outside of gender in the context of romance. Such platform may also consider omitting the implementation of explicit matching contexts in preference sets, relying instead on an implicit matching context or intention of “romance” in every preference set.

In some embodiments, preference sets created from a common PSS, or even different PSS, may share inputs or data. For example only, in an exemplary romance matchmaking platform, each user may be prompted to input their target gender as a global filter. This global gender filter is then automatically applied to all preference sets of each user. Since this exemplary platform only matches users for romance, it may be reasonable to assume that most users are targeting the same gender across all preference sets. Therefore, having a global filter that is set once improves efficiency for most users.

In some embodiments, system 10 may comprise a plurality of separate and predefined environments or modes (EM), each representing fixed matching contexts (MC), such as intentions and/or relationship goals. System 10 clearly displays or advertises the MC of each EM to its matchable entities or users via their electronic devices. System 10 may then allocate a specific PSS for an EM. The PSS of an EM may comprise distinct filters or other possible data elements specifically tailored to the MC of that EM. The MC of a PSS may be implicitly derived from the EM that comprises the PSS. Alternatively, a PSS may include inputs for matchable entities to specify explicit MC, possibly representing narrower MC of the larger MC of the EM that comprises the PSS. The matchable entities may then toggle or switch between these EM to request system 10 for matches. Matchable entities may be allowed to turn on or off an EM to indicate that they are interested or not interested, respectively, in using that EM.

If the MC of the EM are unrelated, then system 10 of such embodiments enables at least one matchable entity access to at least one PSS that allows the creation of a plurality of preference sets. For example only, system 10 may be partitioned into three unrelated EM: “dating”, “friendship”, and “business networking”. Within the “business networking” EM, matchable entities may not have access to any PSS. Even without an explicit preference set, the matchable entities within this EM recognize that the intention behind matching with other matchable entities is for expanding one's business or professional network. Within the “friendship” EM, matchable entities may have access to one PSS that enables each matchable entity to create one preference set. Such PSS may include filter or preference choices specifically tailored for friendship matching which may include, but are not limited to, political views or opinions. Within the “dating” EM, system 10 may provide a PSS that grants each matchable entity the ability to create at least one preference set, while also granting at least one matchable entity the additional privilege of creating a plurality of preference sets. A PSS of the “dating” EM may further include inputs for matchable entities to specify MC related to “dating”, such as “long-term dating”, “short-term dating”, “serious”, “casual”, and/or the like.

If the MC of some EM are related, then system 10 of such embodiments may not need to enable a matchable entity access to a PSS that allows for the creation of a plurality of preference sets. For example only, system 10 may be partitioned into four EM: “dating”, “marriage”, “sugar dating”, and “friendship”. Among these four EM, “dating”, “marriage”, and “sugar dating” are related to romance matchmaking. System 10 may be adapted to provide a PSS with a limit of one preference set for a matchable entity in each of the three romance EM. In aggregate, this would allow the matchable entity to have up to three preference sets, all related to seeking romantic partners. Alternatively, system 10 may provide a PSS that enables a plurality of preference sets for each matchable entity in any to all of the three romance EM and the one “friendship” EM.

An EM that allows a single preference set that cannot be deleted can be construed as a preference set created by system 10, which users can edit. This preference set may have a default state which encompasses all matchable entities on the platform. This default state may be construed as an empty preference set, as it is entirely non-discriminating. For example, if an age filter with a range of 18 to 100 can be configured in this preference set, then the default range in this default state would be 18 to 100, encompassing all matchable entities on the platform. Other possible default states may not be all-encompassing, such as a default age range of 18 to 35.

A PSS and a template of it, as the one illustrated in FIG. 3, may include inputs for specifying an explicit matching context PSS_1. Exemplary common types of matching contexts include, but are not limited to, an intention, a relationship goal, a purpose and/or the like. For example only, a matching context may be as simple as a character value, such as “dating”, “ally”, or “marriage”, selected from a predefined list, or it may involve more complex data structures, such as numeric ranges or role play.

For instance, such more complex data structures may be represented as JSON objects, such as {“goal”: “marriage”, “required_time_of_courtship_in_months”: [6, 24]}. Another exemplary matching context determined by system 10 to be overlapping with it may be represented as {“goal”: “marriage”, “required_time_of_courtship_in_months”: [12, 36]}. Since these two matching contexts share the same goal and overlapping time horizons in terms of expressed courtship length, they may be deemed equal, overlapping, and/or compatible by system 10.

In other examples, complex matching contexts may be represented as the following JSON objects: {“goal”: “employment”, “role_of_match”: “employer”} and {“goal”: “sugar dating”, “role_of_match”: “mentor”}. Matching contexts compatible with the preceding two may include {“goal”: “employment”, “role_of_match”: “employee”} and {“goal”: “sugar dating”, “role_of_match”: “baby”}, respectively. These matching contexts can be construed as including role-play data elements.

With advances in artificial intelligence and statistical models that can process unstructured inputs, a matching context may even include freestyle user inputs, such as freeform text. For example only, a matchable user may be allowed to describe in their own words their intentions and/or goals, such as, “I am pursuing a fun and exciting life without alcohol or drugs”, “marriage with a prenup”, “polygamous romance”, “marriage for the honeymoon only”, “romantic vacation/getaway, approx 3 months duration”, etc. System 10 may be adapted to deploy AI processes to determine whether matching contexts involving freestyle inputs are equal, overlapping, and/or compatible.

Data in a first preference set can be construed as part of the matching context of the first preference set if the data is required to be equal to, overlapping with, and/or compatible with data in another preference set as a matching criterion. For example only, a PSS may include inputs to specify two numbers representing a range of tokens a user must pay to system 10 in order to engage a match. If system 10 requires the first range of the first preference set to overlap with the second range of a second preference set as a criterion for matching, the first range and second range may be construed as part of the matching contexts of the first preference set and second preference set, respectively.

Therefore, a matching context is a concept broader than an intention and, at a minimum, comprises an implicit intention, goal, or purpose. As such, a preference set, at a minimum, comprises an implicit matching context.

In some embodiments, the matching context of a preference set, even if explicitly implemented, may serve no functional purpose in the matching process. Instead, it may simply be displayed on a user's device to inform the user of a match's intent, and possibly other aspects captured in the data of the matching context.

In some embodiments, the matching context may influence the matching process, such as in match ranking or other aspects, but may not serve as a strict criterion for filtering matches.

If a PSS implements an explicit matching context, system 10 may require each preference set created from this PSS to specify a matching context. Alternatively, this PSS may allow a preference set to omit specifying any matching context (i.e., leaving it empty, missing, or to have a value of null) and interpret this as the matchable entity, through this preference set of theirs, being open to matching with any matching contexts. A null (i.e., empty or missing) matching context, under this interpretation, can also be described as being “seeking serendipity”, “open to anything”, or simply, “I don't know”. System 10 may deem a null matching context as compatible with any other matching context, as compatible only with other null matching contexts, or as compatible with only some matching contexts.

Alternatively, a PSS may omit the implementation of an explicit matching context. In such cases, preference sets created from this PSS comprise an implicit matching context. For example, if a platform specializes exclusively in matching users for dating, an explicit matching context may be unnecessary, as the users of this platform are assumed to understand that the purpose of matching is for dating. If this platform enables a user to create a plurality of preference sets from this PSS, it would enable the user to have a plurality of preference sets all related to dating and, by extension, romance.

When a PSS, or a platform altogether, omits explicit matching contexts, the implicit matching context may, alternatively, be “seeking serendipity”, “open to anything”, or simply, “I don't know”. Thus any preference sets created from this PSS, or within this platform, would be related to “seeking serendipity”, “open to anything”, or simply, “I don't know”, respectively. This platform may be construed as specializing in matching the niche of risking-seeking or whimsical individuals.

A PSS may also derive a matching context implicitly from the mode, or environment, in which it is used. For example, a platform may be partitioned into dedicated modes, such as “dating”, “friendship”, “business networking”, etc. The PSS allocated for the “dating” mode may implicitly inherit a “dating” matching context, which users of the platform would reasonably understand. If the PSS of the “dating” mode, for example, enables a plurality of preference sets for a matchable entity, all of them would be related to “dating”.

A PSS may enable a preference set to specify a matching context with multiple intentions, such as those represented in the following JSON array: [“serious-dating”, “casual-dating”]. This scenario could also be construed as multiple matching contexts within the a single preference set. Other matching contexts, such as [“serious-dating”, “marriage”] or “serious-dating”, may be deemed to be overlapping by system 10.

For the same matching context, such as “dating”, system 10 may provide multiple PSS, each with distinct stipulations. A first exemplary PSS for dating may stipulate a distinct model to facilitate engagement between a user and their matches corresponding to preference sets created from the first exemplary PSS, such as a double opt-in mutual liking model for enabling messaging. A second exemplary PSS for dating may stipulate a payment model to facilitate engagement.

A PSS may supply a predefined list of intentions or relationship goals, from which options are selected to serve as the focal point of a matching context. Furthermore, this list may comprise related and unrelated options, such as “dating”, “marriage”, “sugar dating”, “friendship”, “employment”, etc. The PSS may make available distinct filters and/or other data elements to be included in a preference set depending on the selected intention or relationship goal.

A PSS and a template of it, as the one illustrated in FIG. 3, may include inputs for specifying filters PSS_2. For example, filters may be specified for a match's profile, such as gender, age, distance, and so on, or for other aspects related to the match. When expressed in English, exemplary filters for these other aspects may include, but are not limited to: must have at least five pictures, must have at least two preference sets, must have at least five filters per preference set, and must be a premium user.

Although these are filters, system 10 may still treat them with some degree of flexibility. For example only, if a user specifies a distance filter of five miles in a preference set, system 10 may still include other users that are slightly beyond that range as matches corresponding to that preference set. If system 10 generates multiple lists of matches for a preference set, some lists may be generated by processes that disregard the filters entirely, depending on the themes or purposes of the specific lists of matches.

In some embodiments, a matchable entity's relationship goal or intention is placed in the profile as a profile parameter. Another matchable entity can then specify this profile parameter as a filter in their preference sets. This filter may resemble a matching context described in the labeled element PSS_1, but it is more akin to a filter described in the labeled element PSS_2. Even though it may function more as a filter than as a matching context as described herein, it can be construed as specifying an implicit matching context that aligns with the value of the filter.

Other embodiments may implement the intention solely as a profile parameter, without incorporating a filter for this parameter within the preference set. This profile parameter, representing a user's intentions, may serve only to inform other users or may also functionally influence matches generated. A user's preference sets can be construed as deriving an implicit matching context that aligns with the value of this profile parameter.

In some embodiments, a PSS may also enable an entity to specify, in a preference set of the PSS, the intention in another entity's profile as a non-essential preference PSS_3, rather than a filter.

A PSS and a template of it, as the one illustrated in FIG. 3, may include inputs for specifying non-essential preferences PSS_3. Non-essential preferences are similar to filters, except that, rather than being required conditions, they serve as suggestions that system 10 may use to determine compatibility through various methods, such as assigning point scores to matchable entitles based, at least in part, on the matchable entities possessing the non-essential preferences. From these point scores, system 10 may be adapted to rank, sort, and/or prioritize matches in various ways or orders. Non-essential preferences can also apply to the same traits or parameters that filters can apply to, such as gender, age, distance, and so on. For example only, a user may specify a filter for age to be at least twenty years old and a non-essential preference for age to be at least twenty-two years old. Other, softer traits or parameters may be more fitting or natural as non-essential preferences, such as hobbies, interests, opinions, and so on.

A PSS and a template of it, as the one illustrated in FIG. 3, may include inputs for specifying traits or parameters that may signal compatibility between matchable entities PSS_4. A PSS may comprise questionnaires that ask the matchable entity to emphasize certain aspects of their personality or traits. The inputs to these questionnaires may be used by system 10 to determine compatibility, rather than attraction or preference. System 10 may be adapted to seek out matches possessing similar traits to certain traits answered by the matchable entity, as well as complementary, opposing, and/or balancing traits to others. In the context of romance, exemplary traits that may be compatible when similar include, but are not limited to, sense of humor, values, and communication style. On the other hand, traits that may be compatible when complementary, opposing, and/or balancing include, but are not limited to, introversion versus extroversion, organized versus spontaneous, and optimistic versus realistic.

A PSS and a template of it, as the one illustrated in FIG. 3, may include inputs for specifying the sort order of the matchable entities corresponding to a preference set PSS_5. For example, matches may be sorted by distance, income, age, a combination of qualities, etc.

A PSS and a template of it, as the one illustrated in FIG. 3, may include inputs for specifying other configurations regarding resulting matches corresponding to preference sets PSS_6. For example, a user may only want to view certain critical aspects of profiles of matches, such as gender, age, distance, political views, etc.

Furthermore, inputs specified within a preference set are generally not disclosed to matches or other users, as they may reflect discriminating tendencies of the user associated with the preference set, which may be interpreted negatively by matches. Thus, in some embodiments, system 10 may automatically keep all data of a preference set private.

However, discriminating tendencies of a user may also be useful information to a match. Thus, in other embodiments, system 10 may reveal some or all data of a preference set to matches.

Still, in other embodiments, such other configurations PSS_6 may allow the user to configure which aspects of a preference set are revealed to matches. Certain users may be timid to reveal their discriminating tendencies, while other users may want their matches to know what they are seeking.

A PSS and a template of it, as the one illustrated in FIG. 3, may include inputs for specifying what aspects of an entity's own profile that a user of the entity allows matches to see or have access to PSS_7. For example, photos and/or sections of a profile of an entity that are meant to be shown to potential romantic partners may not be shown to matches corresponding to preference sets with non-romantic matching contexts. An entity may specify different public usernames in different preference sets, allowing potentially disparate matches to recognize the entity by the appropriate respective public usernames. In other words, different preference sets of one entity may include the equivalent of different profiles of said entity, which can also be construed as said entity's profile viewed from different perspectives or angles, appropriately tailored to different audiences.

A PSS and a template of it, as the one illustrated in FIG. 3, may include inputs for specifying a unique nickname or identifier for a preference set PSS_8. Such nickname or identifier may be used by the entity associated with the preference set to distinguish the preference set from potentially other preference sets they may have created. Exemplary nicknames, in the context of romance, may include “Mr Perfect”, “Mr Semi Perfect”, “Ordinary Joe”, etc.

A PSS and a template of it, as the one illustrated in FIG. 3, may include inputs for specifying unstructured data, whereby a user describes in their own words who or what their entity is seeking to match with PSS_9. Exemplary unstructured data include, but are not limited to, freeform text inputs and freeform audio inputs. A statistical model, an artificial intelligence model (e.g., a large language model), an indexed search engine, and/or the like may be used by server 24 to determine an entity's matches in part from such unstructured data. For example only, a matchable entity may inform system 10, via freeform text input on their electronic device, that “a match should be interested in marriage, love to travel, love animals, and be spiritual”. In some embodiments, such example freeform text input may also be construed as including a matching context of “marriage”.

Data elements, such as filters and/or non-essential preferences, added to a preference set created from a PSS generally further limit matches that correspond to the preference set. For example, if a preference set includes two filters, gender (“female”) and distance (within 10 miles), it generally requires that both filters be satisfied. However, a PSS may also support “OR” filters, non-essential preferences, and/or other data elements. For example, a PSS may enable a preference set to specify that a match must either be at least six feet or have an income of $100,000. In other words, any additional “OR” conditions or criteria expand the pool of matches that correspond to the preference set.

The data inputted via a template of a PSS to create a preference set forms a subset of data elements that conform to the structure, policies, and/or requirements of the PSS of the template.

The exemplary data elements of a PSS provided herein are for illustration purposes only and should not be construed as exhaustive or limiting. Furthermore, a PSS does not need to include all data elements described herein, and no data element described herein is required.

FIG. 3A is flow diagram showing an illustrated embodiment of a matchmaking process 50 (MMP 50) assigned to an exemplary PSS. System 10 assigns at least one MMP to a PSS to generate matches corresponding to the preference sets conforming to the PSS. One MMP may also be assigned to more than one PSS. System 10 may be adapted to execute MMP 50 on server 24 using the address to database 26 as input.

The exemplary MMP 50 of FIG. 3A begins when it receives a first matchable entity, a first preference set associated with the first matchable entity, and an address to a database as inputs MMP_2. MMP 50 then searches the database associated with the address (e.g., database 26) for other matchable entities satisfying at least a first condition of passing the first preference set MMP_4. If no matchable entities are found, MMP 50 outputs a representation of zero matches MMP_10. If at least one matchable entity is found, MMP 50 transforms, configures, scores, and/or sorts the at least one matchable entity in accordance with the inputs specified in the first preference set MMP_6. From the transformed, configured, scored, and/or sorted matchable entities, MMP 50 outputs at least one matchable entity MMP_8 or, if further conditions are not met, a representation of zero matches MMP_10.

A common occurrence on social media and matchmaking platforms is a user blocking, disliking, or hiding another user. In some embodiments, not being a user who is blocked, disliked, or hidden by or who has blocked or disliked the first matchable entity may be natural additional conditions, among others, in step MMP_4 for determining passing matchable entities or in step MMP_6 for potential further filtering. System 10 may be adapted to allow a matchable entity to block, dislike, and/or hide another matchable entity at different levels of severity, such as limiting the block, dislike, and/or hide action to a particular preference set, matching context, PSS and/or mode. The most severe level of blocking would involve a complete block across all aspects within system 10.

For example only, if the first matchable entity decides that a second matchable entity is a mismatch, i.e., a false positive, for a preference set with a matching context of “marriage”, the first matchable entity could block or dislike the second matchable entity solely for that particular preference set or the matching context of “marriage”, thereby still allowing for the possibility of matching with the second matchable entity through other preference sets or matching contexts, respectively. System 10 may be adapted to allow a matchable entity to undo their block, dislike, and/or hide actions on any or all other matchable entities to which the respective actions haven been applied.

In a modification of the exemplary MMP 50, named MMP 50B, step MMP_4 is altered to include an additional condition in the search. Specifically, MMP 50B searches for matchable entities that satisfy, in addition to the first condition, at least a second condition of having at least one preference set that satisfies at least a third condition of being passed by the first matchable entity, i.e., a mutual preference set.

In a modification of the exemplary MMP 50, named MMP 50B_0, step MMP_4 is altered to include an additional condition in the search. Specifically, MMP 50B_0 searches for matchable entities that satisfy, in addition to the first condition, at least a second condition of having at least one preference set that satisfies at least a third condition of comprising at least one matching context that equals, overlaps, and/or is compatible with at least one matching context of the first preference set, i.e., a mutual preference set.

In a modification of the exemplary MMP 50, named MMP 50B_1, step MMP_4 is altered to include an additional condition in the search. Specifically, MMP 50B_1 searches for matchable entities that satisfy, in addition to the first condition, at least a second condition of having at least one preference set that satisfies at least a third condition of being passed by the first matchable entity and comprising at least one matching context that equals, overlaps, and/or is compatible with at least one matching context of the first preference set, i.e., a mutual preference set.

For example only, if the first preference set includes a matching context with a goal of marriage and a courtship length of six to twenty-four months, a preference set with a matching context aimed at friendship would most likely not be a mutual preference set according to MMP 50B_0 and MMP 50B_1, as these goals would most likely be deemed incompatible. However, another preference set with a matching context aiming for marriage and a courtship length of twelve to thirty-six months, for example, may be considered overlapping or compatible and therefore may be a mutual preference set. In another example, two preference sets that do not specify any matching contexts may be automatically deemed to have compatible matching contexts and therefore may be mutual to each other. In yet another example, a preference set that does not specify any matching contexts may be automatically deemed to have a matching context that is universally compatible with any or all matching contexts. Furthermore, while a relationship goal or intention is the most natural interpretation, any data or input of preference sets that must be equal, overlapping, or deemed compatible by system 10 in order for two preference sets to have a chance of being mutual can be construed as part of the matching context.

Although MMP 50 does not require a mutual preference set in order to produce a match, it may still consider a matchable entity's preference sets when determining whether the matchable entity passes the first preference set. In general, an MMP may consider any data associated with a matchable entity when determining matches.

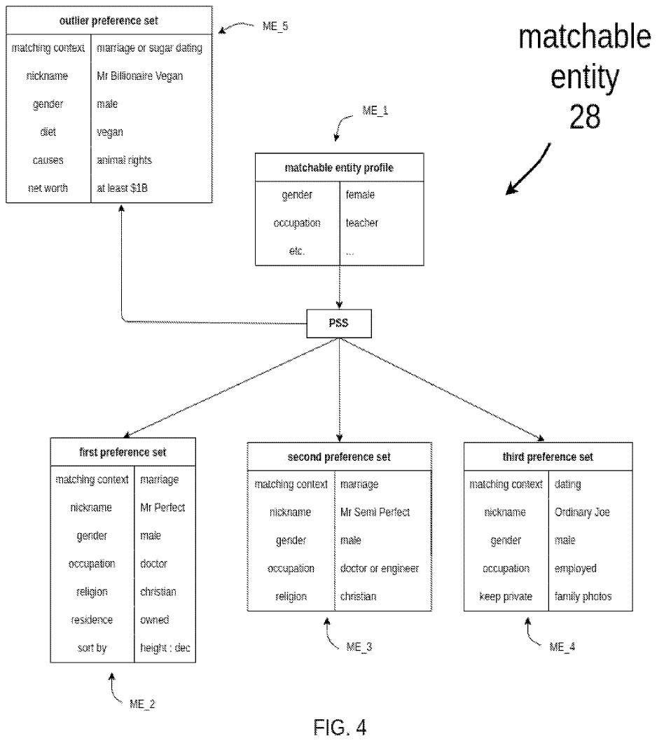

FIG. 4 is a schema diagram showing an illustrated embodiment of a matchable entity (ME 28) with an exemplary profile and four exemplary preference sets created from one PSS. ME 28 is an exemplary matchable user of a system that matches users for romantic connections, such as system 10. ME 28 has self-reported as female and a teacher ME_1. ME 28 has created a first preference set with a matching context (“marriage”), a nickname of “Mr Perfect” (to uniquely identify the preference set), a configuration to sort by height in decreasing order, and filters for gender (“male”), occupation (“doctor”), religion (“christian”), and residence (“owned”) ME_2. ME 28 has created a second preference set with a matching context (“marriage”), a nickname of “Mr Semi Perfect” (to uniquely identify the preference set), and filters for gender (“male”), occupation (“doctor” or “engineer”), and religion (“christian”) ME_3. ME 28 has created a third preference set with a matching context (“dating”), a nickname of “Ordinary Joe” (to uniquely identify the preference set), a configuration to keep ME's 28 family photos in their profile private from the matches corresponding to the third preference set, and filters for gender (“male”) and occupation (“employed”) ME_4. ME 28 has created a fourth, outlier preference set with matching contexts (“marriage” or “sugar dating”), a nickname of “Mr Billionaire Vegan” (to uniquely identify the preference set), and filters for gender (“male”), diet (“vegan”), causes (“animal rights”), and net worth (at least $1,000,000,000) ME_5. The second preference set (“Mr Semi Perfect”) ME_3 can be construed as a compromise or substitute for the first preference set (“Mr Perfect”) ME_2. The third preference set (“Ordinary Joe”) ME_4 can be construed as an immediate or short-term compromise to both the first and second preference sets. The outlier preference set (“Mr Billionaire Vegan”) ME_5 represents a “lottery ticket”, possibly free depending on the model of the platform.

It should be appreciated that allowing such extreme filters (e.g., a net worth of $1,000,000,000) may be feasible only if the platform enables users to create a plurality of preference sets, with some representing realistic yet desirable compromises or substitutes, thereby ensuring the platform's durability to retain users. Despite the extremely small chances of winning, many people still play the real lottery. That's because the cost is also very low. Likewise, the cost of discovering zero matches, i.e., not winning, through a preference set with a filter for a net worth of at least $1,000,000,000, for example, is also very low, likely taking less than a second.

Such extreme preference sets, equivalent to lottery tickets, confer a unique advantage to a durable platform. Their very existence will entice users to log into and use the platform, rather than the possibly multitude of other matchmaking platforms the user may also be a member of. After all, it is reasonable to assume that most people want to know whether they've won the lottery. If a user discovers zero matches, i.e., that they've not won, there is no loss in morale, as there was no expectation to begin with. The user would likely have spent less than a second on this, and possibly zero money as well, depending on the model of the platform. For the remaining hour, which is about the average time a user spends on existing matchmaking platforms, instead of churning to those possibly multitude of other matchmaking platforms, the user simply has to pick a good enough compromise or substitute from one of their other, lesser preference sets. If the user is young, this good-enough compromise might be a fun date, and the young user still has their whole life ahead of them to await the arrival of “Mr Perfect” or “Mr Billionaire Vegan”.

In some embodiments, system 10 may automatically intervene to generate recommended matches or recommended preference sets for a user. For example only, if a particular user has only two preference sets, e.g., “Mr Perfect” and “Mr Billionaire Vegan”, resulting in zero matches, system 10 may be adapted to monitor such a scenario and intervene by automatically generating lists of recommended matches or recommended preference sets that are more likely to result in positive number of matches. System 10 may consider the user's profile traits and parameters, inputs specified in their preference sets, behavior, and/or the like to automatically generate recommended matches (which do not necessarily correspond to any of the user's preference sets) or recommended preference sets based on statistical models, machine learning models, other artificial intelligence models, and/or the like. Additionally, lax matchmaking processes, which may ignore filters, can be applied to the user's preference sets to generate recommended matches corresponding to the preference sets.

In some embodiments, a user of a matchable entity within system 10 creates or modifies a profile and preference sets for the matchable entity and submits them to server 24 via the user's electronic device and cloud 22. Once received, server 24 may be adapted to store said profile and preference sets in database 26 such that they are logically associated with the matchable entity. Server 24 may be adapted to organize the profiles and preference sets of matchable entities in database 26, allowing the data to be indexed for the most common read and/or write queries.

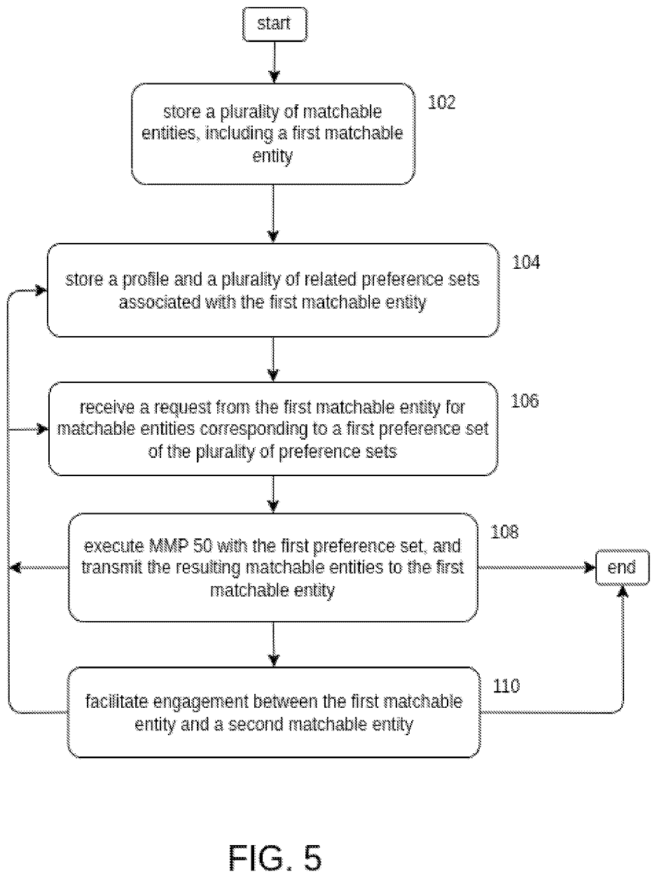

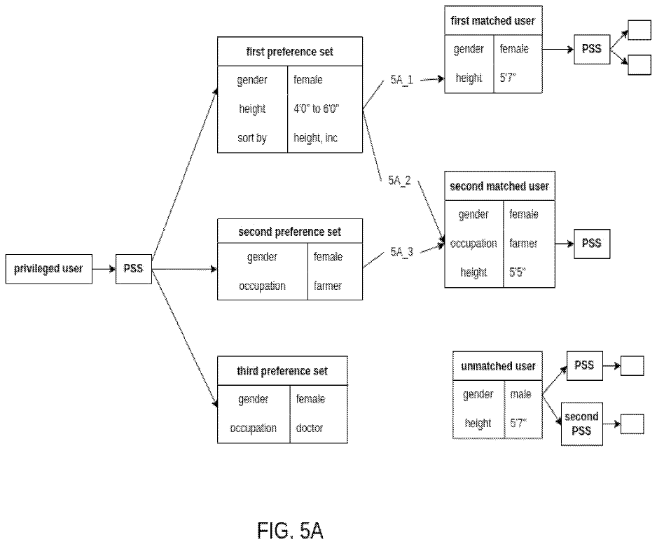

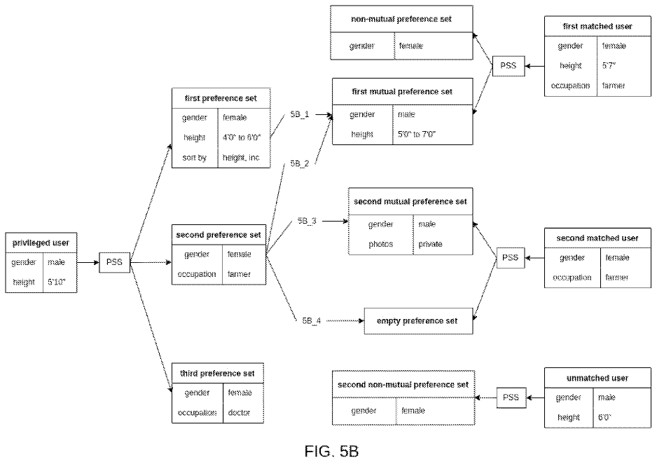

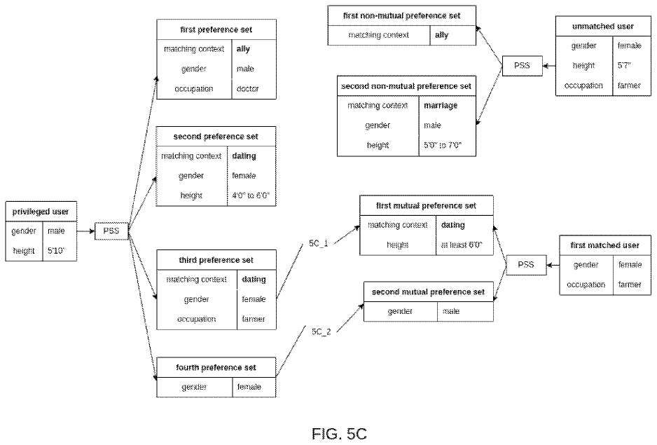

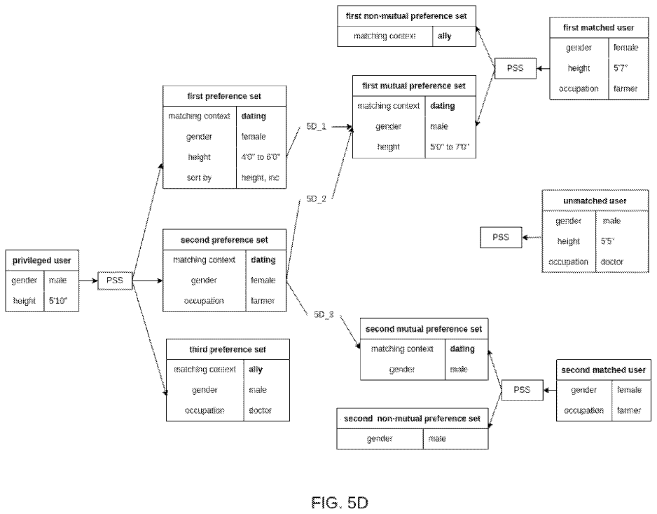

FIG. 5 is a flow diagram showing a first illustrated embodiment of a process 100 of system 10 for retrieving matchable entities corresponding to a selected preference set. Process 100 begins when a plurality of matchable entities, including a first matchable entity, are created and stored in database 26 of system 10 102. The first user 12 of the first matchable entity then creates or modifies a profile and a plurality of preference sets (PPS) that are related for the first matchable entity 104. Likewise, the profiles and preference sets of other matchable entities within system 10 are also created by the entities' respective users. The profiles and preference sets are electronically submitted by the respective users using their devices and transmitted via cloud 22 to server 24, which stores them in database 26. A first preference set is selected from the PPS and a request is made to system 10 from device 16 by first user 12 for matchable entities corresponding to the first preference set for the first matchable entity 106. The request is sent via cloud 22 to the server 24, which executes MMP 50 with the first matchable entity, first preference set, and address to database 26 as inputs to identify matches, and then transmits the matches to device 16 of first user 12 of the first matchable entity 108. The first user 12 may then select a possibly different preference set from the PPS and perform another request 106, modify the profile or existing preference sets or create other preference sets for the first matchable entity 104, or request server 24 to facilitate engagement between the first matchable entity and a second matchable entity of the transmitted matches 110. The first user 12 may then select a possibly different preference set from the PPS and perform another request 106, or modify the profile or existing preference sets or create other preference sets for the first matchable entity 104.

In a modification of the embodiment of process 100, named process 100A, step 104 is modified such that the first matchable entity's PPS may instead be persisted locally in the non-transitory memory of the first user's 12 device 16, rather than in database 26 of system 10. This subsequently requires that step 106 also be modified such that the request to the server 24 includes the selected first preference set's data, rather than just its unique identifier. Persisting (i.e., storing) the PPS locally in the non-transitory memory of the first user's 12 device 16 enables the first user 12 to access the PPS in future sessions, such as the next time they log in, open, and/or connect to system 10 on device 16, as in process 100. In such modification, the first user's 12 device 16 is adapted both to store the PPS locally and attach the first preference set in the API request to server 24.

Process 100 can be further modified depending on the MMP used to determine matches. Process 100 implements an embodiment of MMP 50. Accordingly, processes 100B, 100B_0, and 100B_1 are modifications of process 100 that incorporate MMP 50B, 50B_0, and 50B_1, respectively, to determine matches in step 108.

In modifications of processes 100, 100A, 100B, 100B_0, and 100B_1, step 106 of each is altered so that server 24 receives a request for matchable entities corresponding to at least one of a first selection of preference sets of the PPS associated with the first matchable entity. The first selection includes at least one preference set. A match generated by server 24 of such modified processes may correspond to multiple preference sets of the first selection, and so server 24 may be adapted to transmit additional data to indicate which preference sets of the first selection a match corresponds to. In such modified processes, server 24 may be adapted to execute an instance of the respective MMP for each preference set in the first selection, running them in parallel to identify separate lists of matches. Server 24 may also be adapted to transform and combine the data from each preference set in the first selection into a single aggregate query to database 26 for identifying the matches.

In embodiments that enable matchable entities to engage other matchable entities, processes 100, 100A, 100B, 100B_0, 100B_1, and their modifications can be further modified to distinguish between unengaged matchable entities and already engaged matchable entities (EME). Examples of engagement between matchable entities may include, but are not limited to, interaction activities between them, such as unilateral liking (i.e., an indication of interest), bilateral (i.e., mutual) liking, communication (e.g., text messages), and/or the like.

For example, and for illustration purposes only, said processes may omit EME when retrieving, for a receiving matchable entity or user (RME), unengaged matchable entities corresponding to a first preference set through which those EME and the RME engaged. Such modifications of system 10 may comprise separate processes to retrieve those EME separately for the RME; such separate processes, likewise, may omit unengaged matchable entities when determining those EME. Such separate processes, when determining those EME, may or may not consider the original state of the first preference set, or its current (i.e., possibly edited) state, through which the RME and those EME engaged, and/or the current (i.e., possibly edited) states of the RME and those EME. Such state changes may cause an EME to no longer correspond to the first preference set. Such modifications of system 10 may determine that engagement overrides state changes and thus continue to allow further engagement, that inconsistent state changes override initial engagement and thus prevent further engagement, or enable the RME and those EME to configure whether further engagement is allowed.

FIG. 5A is a schema diagram showing how matches are determined in an exemplary implementation of process 100 or 100A. This is an exemplary process that matches users primarily for romantic connections. The arrow 5A_1 indicates that the first matched user, who is female and 5′7″ in height, is a match for the privileged user, as she passes the privileged user's first preference set, which includes filters for gender (“female”) and height (4′0″ to 6′0″). The second matched user, who is female, a farmer, and 5′5″ in height, is also a match for the privileged user, as she passes the privileged user's first preference set, which includes filters for gender (“female”) and height (4′0″ to 6′0″), as indicated by arrow 5A_2. Additionally, the second matched user also passes the privileged user's second preference set, which includes filters for gender (“female”) and occupation (“farmer”), as indicated by arrow 5A_3. The diagram also shows an unmatched user who is not a match for the privileged user through any of the privileged user's preference sets, as the unmatched user identifies as male. The unmatched user also has access to a second PSS, from which a single preference set is created. The diagram further shows that the privileged user also has a third preference set, which includes filters for gender (“female”) and occupation (“doctor”), that results in zero matches, since no other users self-report as doctors in their profiles.

FIG. 5B is a schema diagram showing how matches are determined in an exemplary implementation of process 100B. This is an exemplary process that matches users primarily for romantic connections. The arrow 5B_1 indicates that the first matched user, who is female, 5′7″ in height, and a farmer, is a match for the privileged user, who is male and 5′10″ in height. This match is based on the privileged user's first preference set, which includes filters for gender (“female”) and height (4′0″ to 6′0″), and the first matched user's first mutual preference set, which includes filters for gender (“male”) and height (5′0″ to 7′0″). The arrow 5B_2 indicates that the privileged user may also be matched with the first matched user via the privileged user's second preference set, which includes filters for gender (“female”) and occupation (“farmer”). The arrow 5B_3 indicates that the second matched user, who is female and a farmer, is a match for the privileged user, who is male and 5′10″ in height. This match is based on the privileged user's second preference set, which includes filters for gender (“female”) and occupation (“farmer”), and the second matched user's second mutual preference set, which includes a filter for gender (“male”) and a configuration to keep her photos private. The arrow 5B_4 indicates that the privileged user may also be matched with the second matched user via the second matched user's empty preference set, which may be automatically passed by the privileged user as such a preference set is non-discriminating. If the server 24 uses the second matched user's second mutual preference set, instead of her empty preference set, as the mutual preference set to the privileged user's second preference set, the privileged user will not be able to see the second matched user's photos. The diagram further shows that the privileged user also has a third preference set, which includes filters for gender (“female”) and occupation (“doctor”), that results in zero matches, since no other users self-report as doctors in their profiles. The diagram further shows that the first matched user also has a non-mutual preference set, which includes a filter for gender (“female”). This non-mutual preference set is not passed by the privileged user, who is male. The diagram also shows an unmatched user, a 6′0″ male, who has one preference set, nicknamed second non-mutual preference set, with a filter for gender (“female”). The privileged user and the unmatched user have no preference sets that are passed by the other, and are thus not matches to each other under process 100B.

FIG. 5C is a schema diagram showing how matches are determined in an exemplary implementation of process 100B_0. This is an exemplary process that matches users primarily for romantic connections. The diagram shows a privileged user who has a total of four preference sets, an unmatched user, and a first matched user. The first preference set of the privileged user has a matching context (“ally”) and filters for gender (“male”) and occupation (“doctor”), which results in zero matches since no other user identifies as male or a doctor. The second preference set of the privileged user has a matching context (“dating”) and filters for gender (“female”) and height (4′0″ to 6′0″), which results in zero matches since the first matched user does not pass the height filter and the unmatched user does not have a preference set with a matching context of “dating”. The arrow 5C_1 indicates that the first matched user, who is female and a farmer, is a match for the privileged user, who is male and 5′10″ in height. This match is based on the privileged user's third preference set, which includes a matching context (“dating”) and filters for gender (“female”) and occupation (“farmer”), and the first matched user's first mutual preference set, which includes a matching context (“dating”) and a filter for height (at least 6′0″). It should be appreciated that the privileged user's height does not pass the first mutual preference set's height filter (at least 6′0″); therefore, it should also be appreciated that the match relationship represented by arrow 5C_1 is not bi-directional (i.e., not mutual) in that, the privileged user would not be a match transmitted to the first matched user's device if the first matched user were to request server 24 for matches corresponding to the first mutual preference set. The arrow 5C_2 indicates that the first matched user is also a match for the privileged user based on the privileged user's fourth preference set, which includes a null matching context and a filter for gender (“female”), and the first matched user's second mutual preference set, which also includes a null matching context and a filter for gender (“male”). In this implementation, two null matching contexts are deemed compatible. It should be appreciated that the match relationship represented by arrow 5C_2 is bi-directional (i.e., mutual).

FIG. 5D is a schema diagram showing how matches are determined in an exemplary implementation of process 100B_1. This is an exemplary process that matches users primarily for romantic connections. The arrow 5D_1 indicates that the first matched user, who is female, 5′7″ in height, and a farmer, is a match for the privileged user, who is male and 5′10″ in height. This match is based on the privileged user's first preference set, which includes a matching context (“dating”) and filters for gender (“female”) and height (4′0″ to 6′0″), and the first matched user's first mutual preference set, which includes a matching context (“dating”) and filters for gender (“male”) and height (5′0″ to 7′0″). The arrow 5D_2 indicates that the privileged user may also be matched with the first matched user via the privileged user's second preference set, which includes a matching context (“dating”) and filters for gender (“female”) and occupation (“farmer”). The arrow 5D_3 indicates that the second matched user, who is female and a farmer, is a match for the privileged user, who is male and 5′10″ in height. This match is based on the privileged user's second preference set, which includes a matching context (“dating”) and filters for gender (“female”) and occupation (“farmer”), and the second matched user's second mutual preference set, which includes a matching context (“dating”) and a filter for gender (“male”). The diagram also shows an unmatched user who is not a match for the privileged user because the unmatched user has not yet created any preference sets, which implies that the unmatched user has no mutual preference sets for the privileged user to pass. This exemplary process treats the scenario where a user has not created any preference sets as an indication that the user is not looking to match with others at the moment. The diagram further shows that the privileged user also has a third preference set, which includes a matching context (“ally”) and filters for gender (“male”) and occupation (“doctor”), that results in zero matches, since no other users self-report as doctors in their profiles and are looking to match as allies. The diagram further shows that the first matched user also has a first non-mutual preference set, which includes a matching context (“ally”) and no filters. The diagram further shows that the second matched user also has a second non-mutual preference set, which includes a filter of gender (“male”) and no matching context. An empty (i.e., null or missing) matching context is not deemed compatible with a non-empty matching context in this exemplary process, and therefore the second matched user's second non-mutual preference set cannot be deemed a mutual preference set to any of the privileged user's preference sets, as each of the privileged user's preference sets has a non-empty matching context. It should be appreciated that, in other implementations, a null matching context may automatically be deemed compatible with any other matching context, whether null or not null.

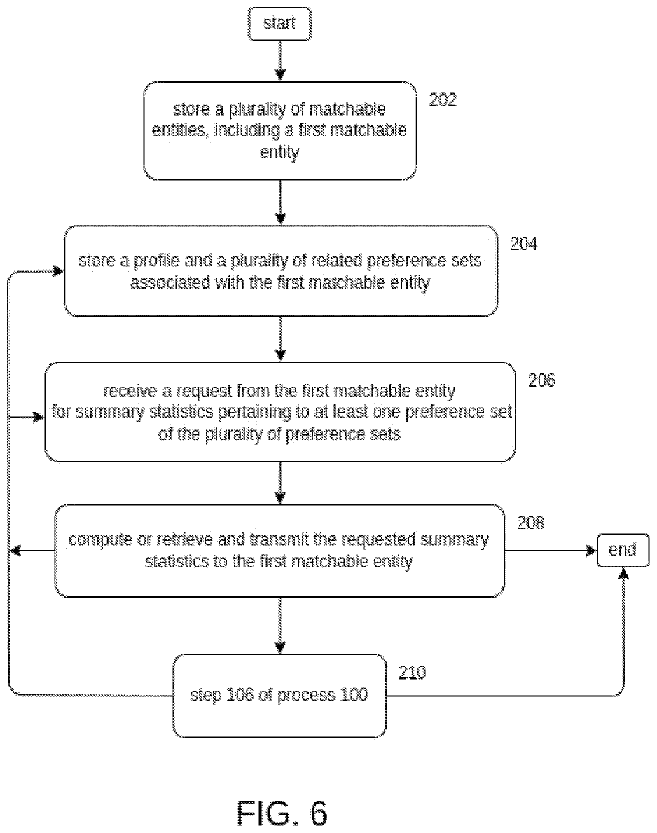

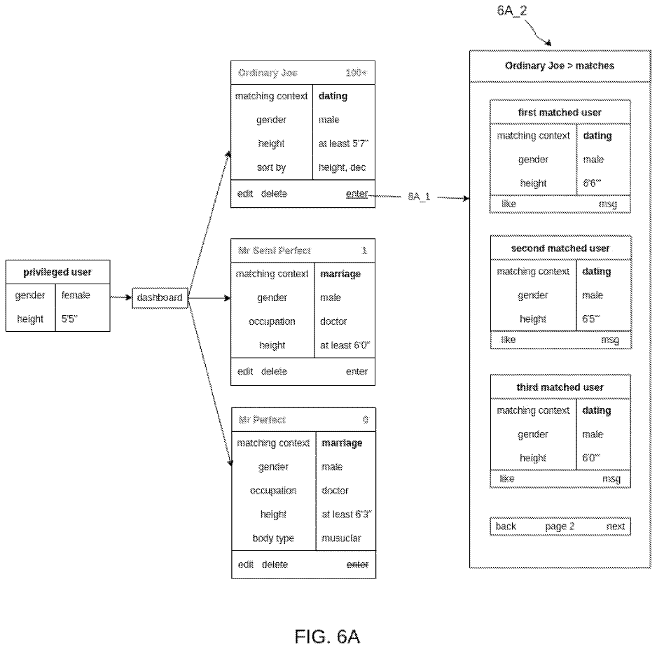

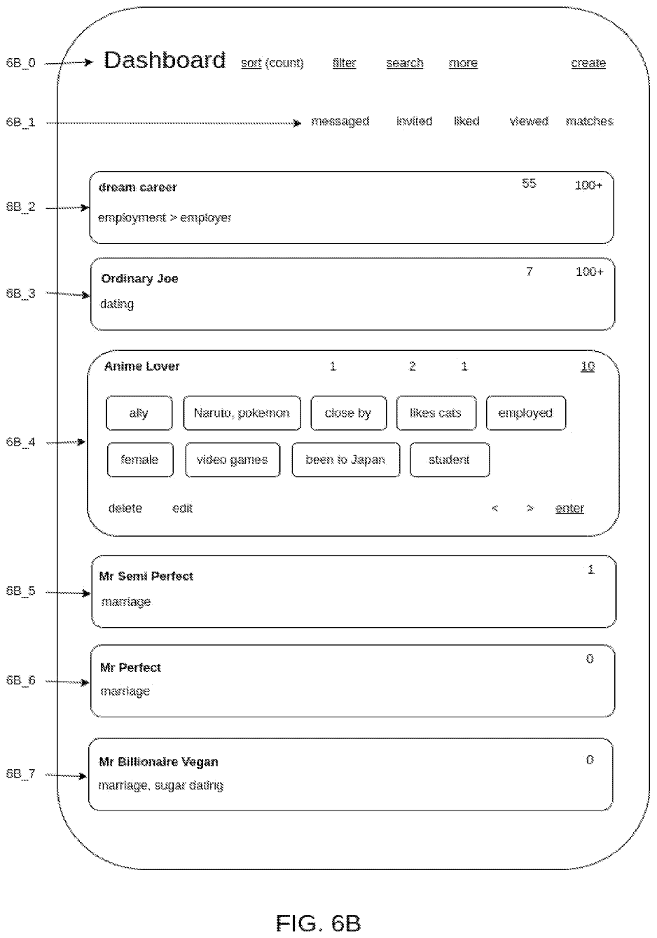

FIG. 6 is a flow diagram showing a first illustrated embodiment of a process 200 of system 10 for retrieving summary statistics pertaining to at least one preference set. Process 200 begins when a plurality of matchable entities, including a first matchable entity, are created and stored in database 26 of system 10 202. The first user 12 of the first matchable entity then creates or modifies a profile and a plurality of preference sets (PPS) that are related for the first matchable entity 204. Likewise, the profiles and preference sets of other matchable entities within system 10 are also created by the entities'respective users. The profiles and preference sets are electronically submitted by the respective users using their devices and transmitted via cloud 22 to server 24, which stores them in database 26. At least one preference set is selected from the PPS and a request is made to system 10 from device 16 by first user 12 to retrieve summary statistics pertaining to the at least one selected preference set for the first matchable entity 206. The request is sent via cloud 22 to the server 24, which parses the at least one preference set, searches database 26 to compute or retrieve summary statistics pertaining to the at least one preference set, and then transmits the summary statistics to device 16 of first user 12 of the first matchable entity 208. The first user 12 may then select at least one possibly different preference set from the PPS and perform another request 206, modify the profile or existing preference sets or create other preference sets for the first matchable entity 204, or step into process 100 starting at step 106. The first user 12 may then select at least one possibly different preference set from the PPS and perform another request 206, or modify the profile or existing preference sets or create other preference sets for the first matchable entity 204.

Process 200 may be modified depending on the process used to determine matches. For example, the counts of matches, and possibly other summary statistics, such as engagement activities or counts, may vary across the different processes used to determine matches: process 100, process 100A, process 100B, process 100B_0, and process 100B_1. Process 200 implements the matching process of process 100. Accordingly, processes 200A, 200B, 200B_0, and 200B_1 are modifications of process 200 that incorporate modified processes 100A, 100B, 100B_0, and 100B_1, respectively, of process 100 to determine matches. Step 210 of processes 200A, 200B, 200B_0, and 200B_1 are accordingly modified to step into processes 100A, 100B, 100B_0, and 100B_1, respectively, starting at step 106. In process 200A, the PPS of the first matchable entity is stored locally in the non-transitory memory of device 16 of the first user 12, as in process 100A.

The exemplary implementation of FIG. 5A shows that, in accordance with processes 200 and 200A, the first, second, and third preference sets of the privileged user have match counts of two, one, and zero, respectively.

The exemplary implementations of FIG. 5B and FIG. 5D show that, in accordance with processes 200B and 200B_1, respectively, the first, second, and third preference sets of the privileged user have match counts of one, two and zero, respectively.

The exemplary implementation of FIG. 5C shows that, in accordance with process 200B_0, the first, second, third, and fourth preference sets of the privileged user have match counts of zero, zero, one, and one, respectively.

Summary statistics of a preference set may include, but are not limited to, the count or approximation of matches, the count of viewed matchable entities, the count of engaged matchable entities (e.g., matchable entities with whom messages or likes have been exchanged), and/or similar metrics. Summary statistics help a user focus or refine their search and make better decisions, such as whether to relax the filters of certain preference sets if there are not enough matches or tighten those filters if there are too many matches. It informs a user of who is available at the moment and who they still need to wait for.

Embodiments of process 200 and its modifications may also compute more sophisticated summary statistics pertaining to a preference set of a matchable entity. These more sophisticated summary statistics may include, but are not limited to, a metric indicating the level of restrictiveness of the preference set, a metric indicating the probability of a positive match count within a given period, a metric indicating the difference in attractiveness between the profile of a potential match corresponding to the preference set and the matchable entity's own profile.

The combination of having a plurality of preference sets and their summary statistics provides the user with yet another unique ability to compare and contrast across preference sets, thereby forming a comprehensive picture that aids in navigating and choosing paths.

While not every person is a perfectionist, it can be assumed that most people aim to match “upwards” but are willing to compromise when necessary, unlike a perfectionist. The ability to create a plurality of preference sets related to romance, aided by helpful, auxiliary summary statistics and possibly more filter options, solves yet another problem of enabling a user to discover their “ceiling” in the marketplace of romance. To discover one's ceiling, a user would create a first preference set and see how many matches it yields. If it yields zero matches, then this user has discovered their ceiling and would proceed to create their second, third, fourth, and subsequent preference sets, progressively relaxing their requirements after each, until they get to one that yields a positive number of matches. On the other hand, if the first preference set yields a positive number of matches, the user would then proceed to create their second, third, fourth, and subsequent preference sets, progressively tightening their requirements after each, until they get to one that yields zero matches, their ceiling.

Many people would agree that finding the right romantic life partner is the most important aspect of life. Thus, the marketplace of romance may be the most significant marketplace in life. The optimal marketplace may be one where most users can efficiently match with others just below their ceiling.

Once these summary statistics are transmitted to the first user's 12 device, they can be organized into a dashboard and displayed to the first user 12. The first user's 12 preference sets in the dashboard could be sorted or filtered by any combination of these summary statistics.

FIG. 6A is a schema diagram showing how a first exemplary embodiment of a user dashboard, which enables a user to access their preference sets, may be implemented on a device of an entity. The exemplary privileged user has three preference sets, with nicknames “Ordinary Joe”, “Mr Semi Perfect”, and “Mr Perfect”. On the graphical user interface (GUI) of the privileged user's device, there is a dashboard view that comprises interactive child widgets representing the privileged user's preference sets. A preference set widget may display the nickname of the preference set on the header and a count or an approximation of matchable entities corresponding to the preference set. The dashboard in this exemplary embodiment is sorted by said count. A preference set widget may also display the inputs or data of the preference set. If the data of the preference sets are stored in database 26, as opposed to the local non-transitory memory of the privileged user's device, the privileged user's device has to perform a request via cloud 22 to the server 24 to retrieve the data. In order to compute the count or approximation of matchable entities corresponding to a preference set, the privileged user's device also has to perform a request to the server 24. These counts may have been cached by the server 24 in database 26, or they may be computed upon request by the privileged user. The user's device may send one request per preference set widget in parallel or may send aggregated requests for the data or counts of the preference sets. A preference set widget also contains interactive elements, such as buttons to edit or delete the preference set and an “enter” button to request for matchable entities corresponding to the preference set. The “enter” button may be disabled if zero matches are detected, as is the case for the preference set nicknamed “Mr Perfect”. Once the “enter” button of a preference set widget is pressed 6A_1, the privileged user's device may perform another request to the server 24 via cloud 22 to retrieve the matchable entities corresponding to the preference set. The GUI of the privileged user's device automatically transitions to a new view or display, which may be another dashboard that comprises child widgets representing the matched matchable entities, such as the dashboard 6A_2 displaying matches corresponding to the preference set nicknamed “Ordinary Joe” of the privileged user. A matchable entity widget contains displays of the matchable entity and interactive tools for the privileged user to engage the matchable entity, if they are interested. These tools may include a button to like the entity, a button to message the entity, and/or the like.

FIG. 6B is a user graphical interface display showing how a second exemplary embodiment of a user dashboard, which enables a user to access their preference sets, may be implemented on device 16 of the first user 12. The exemplary dashboard embodiment is partitioned into a top or header row and a body. The top row, 6B_0, is the header of the dashboard, which comprises five functional buttons: sort, filter, search, more and create. The body of the dashboard, which contains the widgets representing the preference sets, is sorted in descending order by the match counts of the preference sets at the moment, but the first user 12 has the option to change the summary statistic and/or the sort direction used for sorting the preference sets by accessing the sort button in the top row, 6B_0. Also in the top row, 6B_0, the first user 12 can filter the preference sets to find a subset with certain properties or summary statistics, search the preference sets by their nicknames, and create new preference sets. The more button could contain additional functionality, such as deactivating, pausing (i.e., suspending), deleting multiple preference sets at once, and/or similar aggregate actions.

The body of the exemplary dashboard illustrated in FIG. 6B is partitioned into rows and columns. The row 6B_1 displays the names of the columns at the position or index of the column: messaged, invited, liked, viewed, matches. These are the names of exemplary summary statistics pertaining to the first user's 12 preference sets. The numbers under each respective column, contained within a particular preference set widget, represent to the values of the associated summary statistic of the column for a particular preference set.

The body of the exemplary dashboard illustrated in FIG. 6B of the first user 12 includes a widget representing a preference set nicknamed “dream career” that has a role-based matching context of “employment” in which matches serve the role of potential employers to the first user 12, a viewed count of 55, and a match count of more than 100 6B_2. The body further includes a widget representing a preference set nicknamed “Ordinary Joe” that has a romance matching context of “dating”, a viewed count of 7, and a match count of more than 100 6B_3.

The body of the exemplary dashboard illustrated in FIG. 6B of the first user 12 further includes a widget representing a preference set nicknamed “Anime Lover”, which is the focused or expanded widget of the dashboard at the moment, that has a platonic matching context of “ally”, a messaged count of 1, an invited count of 2, a liked count of 1, and a match count of 10 6B_4. This focused or expanded widget displays the data associated with the preference set, representing the qualities or attributes that the first user 12 is looking for in their matches corresponding to this preference set. A widget can be focused or expanded by clicking with a mouse or tapping the touchscreen on the widget. These attributes include an interest in the anime series of Naruto and Pokemon, an interest in video games, being geographically located close by, liking cats, being employed, being female, having been to Japan, and being a student. This focused or expanded widget enables and reveals three functional buttons: delete, edit, and enter. The first user 12 may delete or edit the preference set represented by the widget. The first user 12 may press the enter button to query for the 10 matches, 1 liked matches, 2 invited matches, or 1 messaged match, depending on which summary statistic is focused at the moment of the button press. The first user 12 may switch or toggle the focused summary statistic by pressing on the summary statistics directly or the left or right icon buttons next to the enter button. The match count of 10 is underlined, indicating that it is the focused summary statistic at the moment.

The body of the exemplary dashboard illustrated in FIG. 6B of the first user 12 further includes a widget representing a preference set nicknamed “My Semi Perfect” that has a romance matching context of “marriage” and a match count of 1 6B_5. The body further includes a widget representing a preference set nicknamed “Mr Perfect” that also has a romance matching context of “marriage” but a match count of 0 6B_6. The body further includes a widget representing a preference set nicknamed “Mr Billionaire Vegan” that has romance matching contexts of “marriage” and “sugar dating” but a match count of 0 6B_7.

The exemplary dashboard of the first user 12, illustrated in FIG. 6B, is adapted to omit the display of summary statistics with values equal to zero, except for match counts, which are displayed on the rightmost column even when their values are zero, as is the case for “Mr Perfect” and “Mr Billionaire Vegan”.

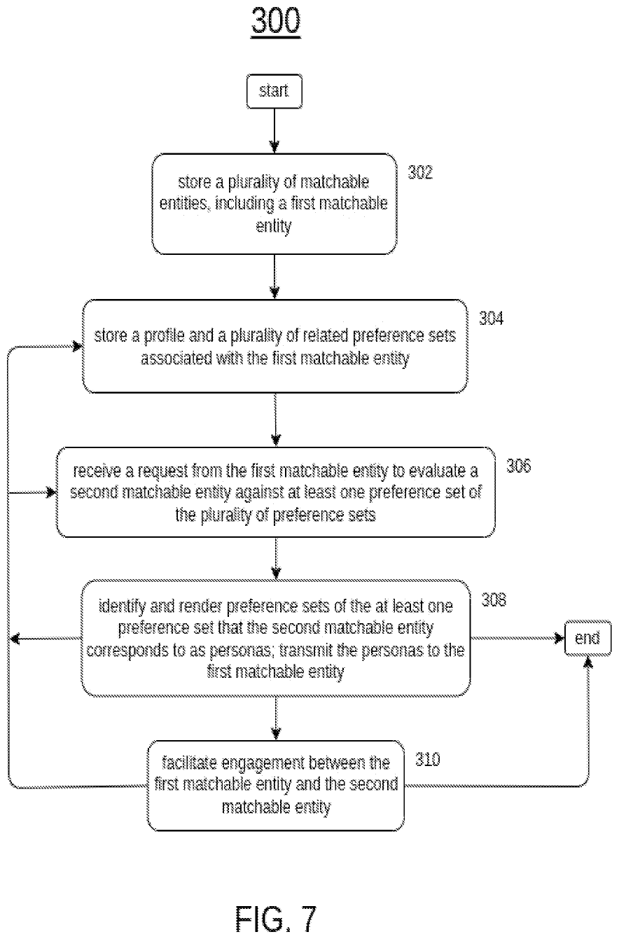

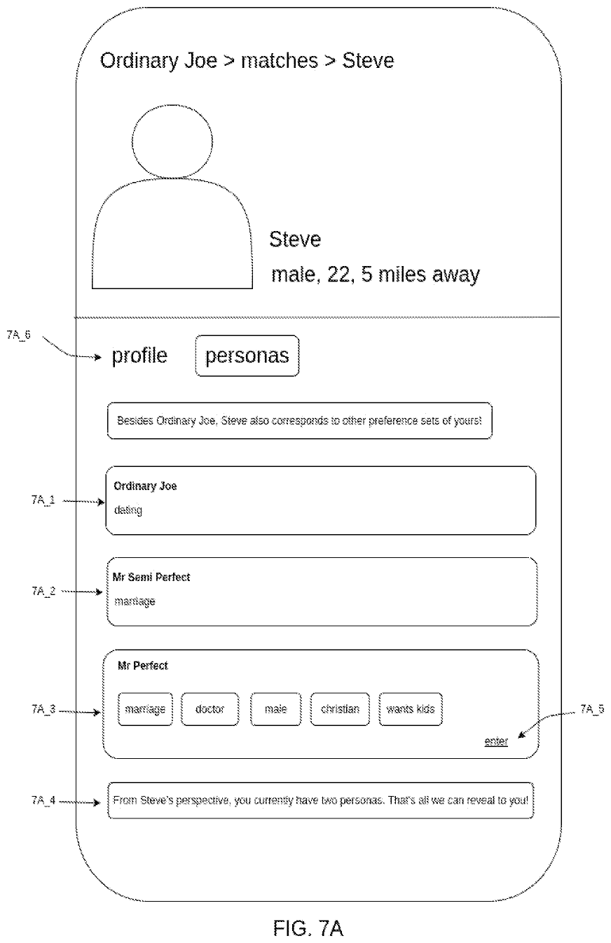

FIG. 7 is a flow diagram showing a first illustrated embodiment of a process 300 of system 10 for determining personas of a second matchable entity associated with the second user 14 from the perspective of a first matchable entity associated with the first user 12. The second matchable entity may be identified through multiple distinct matches (i.e., personas) to the first matchable entity if the second matchable entity corresponds to multiple preference sets associated with the first matchable entity.

This scenario can be illustrated with an example from the context of romance. A first matchable user may have three preference sets: Mr Perfect, Mr Semi Perfect, and Ordinary Joe. It is likely that if a second matchable user passes as Mr Perfect, they would also pass as Mr Semi Perfect and Ordinary Joe. If the first matchable user matched with the second matchable user through the Ordinary Joe preference set, it would be unfortunate if the first matchable user doesn't realize that this Ordinary Joe (i.e., the second matchable user) is also Mr Perfect.

Thus, a need has arisen to ensure that a user efficiently obtains a complete view of the different personas of a match from the user's own perspective, i.e., their preference sets.

Process 300 begins when a plurality of matchable entities, including a first matchable entity and a second matchable entity, are created and stored in database 26 of system 10 302. The first user 12 of the first matchable entity then creates or modifies a profile and a plurality of preference sets (PPS) that are related for the first matchable entity 304. Likewise, the profiles and preference sets of other matchable entities within system 10 are also created by the entities'respective users. The profiles and preference sets are electronically submitted by the respective users using their devices and transmitted via cloud 22 to server 24, which stores them in database 26. At least one preference set is selected from the PPS and a request is made to system 10 from device 16 by first user 12 to evaluate the second matchable entity against the at least one preference set 306. The request is sent via cloud 22 to the server 24, which parses the at least one preference set, identifies preference sets of the at least one preference set that the second matchable entity corresponds to, renders these preference sets as personas, and then transmits these personas to device 16 of first user 12 of the first matchable entity via cloud 22 308. The first user 12 may then select at least one possibly different preference set from the PPS and perform another request 306, modify the profile or existing preference sets or create other preference sets for the first matchable entity 304. Server 24 may then facilitate engagement between the first user 12 of the first matchable entity and the second user 14 of the second matchable entity, if there is any interest, via first user's 12 device 16, second user's 14 device 18, and cloud 22 310. The first user 12 may then select at least one possibly different preference set from the PPS and perform another request 306, modify the profile or existing preference sets or create other preference sets for the first matchable entity 304.

Process 300 can be modified depending on the process used to determine matches. Process 300 implements the matching process of process 100. Accordingly, processes 300A, 300B, 300B_0, and 300B_1 are modifications of process 300 that incorporate modified processes 100A, 100B, 100B_0, and 100B_1, respectively, of process 100 to determine matches. In process 300A, the PPS of the first matchable entity is stored locally in the non-transitory memory of device 16 of the first user 12, as in process 100A.

The exemplary implementation of FIG. 5A shows that, in accordance with processes 300 and 300A, the second matched user has two personas from the perspective of the privileged user. Arrow 5A_2 indicates that one of those personas corresponds to the first preference set, while arrow 5A_3 indicates that the other persona corresponds to the second preference set.

The exemplary implementations of FIG. 5B and FIG. 5D show that, in accordance with processes 300B and 300B_1, respectively, the first matched user has two personas from the perspective of the privileged user. Arrows 5B_1 and 5D_1, respectively, indicate that one of those personas corresponds to the first preference set, while arrows 5B_2 and 5D_2, respectively, indicate that the other persona corresponds to the second preference set.

In modifications of processes 300, 300B, 300B_0, and 300B_1, step 306 is modified or augmented to receive a request from the first matchable entity to evaluate the first matchable entity against the preference sets associated with the second matchable entity. Step 308 of these modified processes is subsequently also modified or augmented to transmit information regarding the preference sets associated with the second matchable entity that the first matchable entity corresponds to to device 16 of the first user 12 of the first matchable entity. Such information may include, but are not limited to, the number of preference sets associated with the second matchable entity that the first matchable entity corresponds to, the matching contexts of the preference sets associated with the second matchable entity that the first matchable entity corresponds to, and/or the like. The quantity and type of said information to reveal to the first user 12 of the first matchable entity may be determined by balancing the privacy concerns of the second user 14 of the second matchable entity with the usefulness of said information to the first user 12. System 10 may enable the second user 14 to configure what or how much of said information to reveal.

The exemplary implementation of FIG. 5B shows that, in accordance with process 300B, when evaluated against the preference sets of the second matched user, the privileged user corresponds to both of the second matched user's preference sets, resulting in two personas from the perspective of the second matched user. This fact or count could be part of the information revealed to the privileged user.

The possibly multiple distinct personas of the second matchable entity corresponding to the preference sets associated with the first matchable entity and/or information regarding the preference sets associated with the second matchable entity that the first matchable entity corresponds to can also be organized and represented to the first user 12 in graphical user interface dashboards on device 16. Within one possible dashboard, each persona of the second matchable entity can be represented by a dedicated GUI widget.

FIG. 7A illustrates an exemplary graphical user interface (GUI) profile page, wherein a dashboard displays the personas of a second matchable entity from the perspective of a first matchable entity. This dashboard is implemented on a device associated with the first matchable entity. The second matchable entity has a public username, Steve, and corresponds to a preference set nicknamed “Ordinary Joe” of the first matchable entity. From the perspective of the first matchable entity, the second matchable entity corresponds to a total of three personas: “Ordinary Joe” 7A_1, “Mr Semi Perfect” 7A_2, and “Mr Perfect” 7A_3, with matching contexts of “dating”, “marriage”, and “marriage”, respectively.

This dashboard further informs the first matchable entity that they correspond to two personas from the perspective of the second matchable entity 7A_4.

FIG. 7A further illustrates that each persona is represented by a GUI widget. In particular, the widget 7A_3, representing the persona “Mr Perfect”, is the expanded or focused widget at the moment, which can be achieved by clicking with a mouse or tapping the touchscreen on the widget. As a result of being expanded or focused, it displays the data of the preference set, enabling the first matchable entity to quickly view and be reminded of the inputs specified in the preference set. If the first matchable entity clicks on the “enter” button 7A_5, system 10 automatically transitions Steve's profile from the persona “Ordinary Joe” to the perspective of “Mr Perfect”, providing a more comprehensive view of Steve's profile from that persona's perspective.

FIG. 7A further illustrates that the profile page includes a “profile” button or link 7A_6. Pressing this button automatically transitions the page to Steve's full profile from the perspective of “Ordinary Joe”, or whichever persona that the page is rendered for at the moment. Within the full profile tab of the page, system 10 may highlight specific traits or parameters of Steve's profile from the perspective of the respective persona, which is “Ordinary Joe” at the moment.

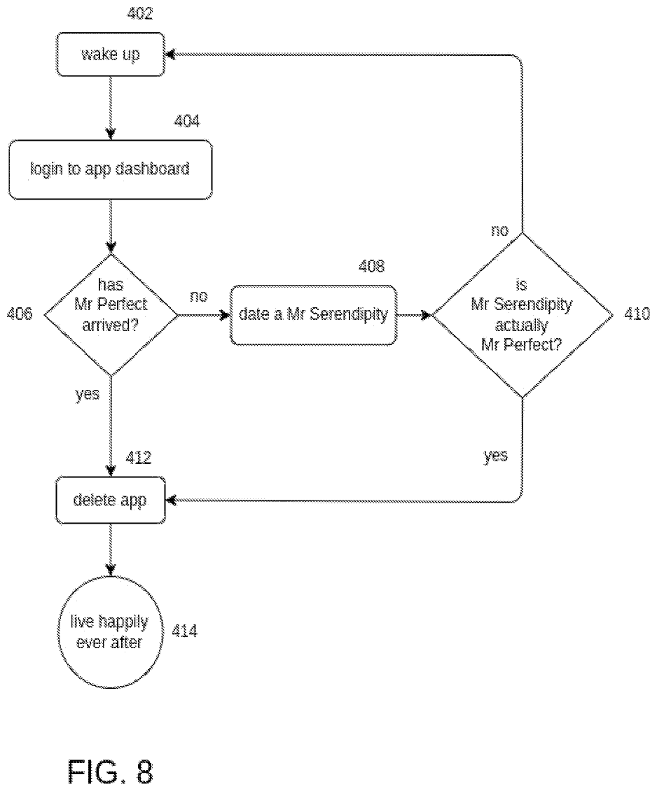

FIG. 8 is a flow diagram showing an exemplary user workflow of a process 400 of system 10. Such a user workflow is enabled by the first user 12 having the ability to create a plurality of preference sets related to romance. In the context of romance, there may be two possible types of matches. The first type is another user who, on paper, has the qualities or attributes that the first user 12 “knows” they are looking for in a match, i.e., “Mr Perfect”. The second type is another user who may possess qualities or attributes that the first user 12 didn't know they were looking for in a match, i.e., “Mr Serendipity”. “Mr Perfect” and “Mr Serendipity” are exemplary preference sets with widgets on the first user's 12 dashboard. The difference between these two preference sets lies in the quantity and/or strictness of their filters or preferences. This difference implies that “Mr Perfect” will most likely have an empty match count, while the match count of “Mr Serendipity” will most likely be a healthy, positive number. “Mr Perfect” is the first user's 12 first choice, as it is often said. “Mr Serendipity” may have to be engaged with in order to discover their potentially unknown but desirable qualities or attributes.

Process 400 begins when the first user 12 wakes up 402. The first user 12 then logins into the system 10 from their device 16 to view their dashboard 404. The first user 12 checks the match count of their preference set nicknamed “Mr Perfect” 406. If this number is greater than zero, the first user 12, after engaging a matchable entity corresponding to “Mr Perfect”, deletes the app 412 and lives happily ever after 414. If this number is zero, the first user 12 engages with a matchable entity corresponding to another one of their preference sets nicknamed “Mr Serendipity” 408. The first user 12 then decides whether the “Mr Serendipity”, with whom they engaged (i.e., dated), possesses unexpected desirable qualities or attributes that actually make them “Mr Perfect” 410. If the “Mr Serendipity” does possess these qualities or attributes, the first user 12 deletes the app 412 and lives happily ever after 414. If the “Mr Serendipity” does not possess these qualities or attributes, the first user 12 sleeps it off and wakes up the next day to repeat the process 402.

For simplicity of explanation, processes 50, 100, 200, 300, 400 and their modifications are depicted and described as a series of steps. However, steps in accordance with this disclosure can occur in various orders and/or concurrently. Additionally, steps in accordance with this disclosure may occur with other steps not presented and described herein. Furthermore, not all illustrated steps may be required to implement a method in accordance with the disclosed subject matter.

The words “example” or “exemplary” are used herein to mean serving as an example, instance, or illustration. Any aspect or design described herein as “example” or “exemplary” is not necessarily to be construed as preferred or advantageous over other aspects or designs, nor should it be construed as limiting or exhaustive. Rather, use of the phrases “example”, “exemplary”, “instance”, “for example”, “for example only”, or “for instance” is intended to present or illustrate concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances.

In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Examples of additional features and/or benefits have been described as potential consequences or side effects of some embodiments of the present disclosure. For instance, implementing an embodiment of the present disclosure may enable a platform to additionally extend its list of filter options and/or enhance the rigor of its matching processes. However, it should be understood that these additional features are optional.

While the present disclosure has been described in connection with certain embodiments and their modifications, it is to be understood that the invention is not to be limited to the disclosed embodiments or their modifications but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A computer-implemented method for entity matching, comprising:
storing a plurality of matchable entity profiles (PMEP) in at least one database (database), the PMEP associated with a plurality of matchable entities (PME), the PME associated with a plurality of users (PU);
receiving a plurality of preference sets (PPS) associated with a first matchable entity of the PME, the PPS electronically submitted by a first user of the PU using at least one electronic device, the first user associated with the first matchable entity, the PPS satisfying at least one of: all conforming to a first preference superset, all associating with a first mode, all associating with a first space, all associating with a first environment, all comprising related matching contexts, all comprising related intentions, all comprising related goals, all comprising related purposes, all relating to seeking professional connections, all relating to seeking employment, all relating to seeking platonic companions, and all relating to seeking at least one of romantic partners and sexual partners; and
performing at least one of:
transmitting a computer-readable representation of at least one matchable entity of the PME that corresponds to at least one preference set of the PPS to at least one electronic device associated with the first user, hereafter referred to as matches;
transmitting a computer-readable representation of zero matches to at least one electronic device associated with the first user; and
rendering a display representing zero matches on at least one electronic device associated with the first user.

2. The method of claim 1, wherein the PPS further satisfying at least one of: all having the same matching context; all having the same intention; all having the same goal; all having the same purpose; and all having a first configurable input, the first configurable input configured to a unique value for each preference set of the PPS by the first matchable entity using at least one electronic device, the unique value to the first configurable input of each preference set determining a unique list of matches for each preference set of the PPS.

3. The method of claim 1, further comprising locally storing the PPS in the non-transitory memory of at least one electronic device associated with the first user.

4. The method of claim 1, further comprising storing the PME and PPS in the database.

5. The method of claim 4, wherein a match has at least one preference set that is passed by the first matchable entity.

6. The method of claim 4, wherein a match has at least one preference set that comprises at least one matching context that is at least one of equal to, overlapping with, and compatible with at least one matching context of at least one preference set of the PPS that the match corresponds to.

7. The method of claim 4, wherein a match has at least one preference set that is passed by the first matchable entity and comprises at least one matching context that is at least one of equal to, overlapping with, and compatible with at least one matching context of at least one preference set of the PPS that the match corresponds to.

8. The method of claim 1, further comprising transmitting a computer-readable representation of at least one summary statistic pertaining to at least one preference set of the PPS to at least one electronic device associated with the first user.

9. The method of claim 8, further comprising rendering a graphical user interface (GUI) dashboard on at least one electronic device associated with the first user, the GUI dashboard comprising at least one GUI widget, each GUI widget representing an individual preference set of the PPS, each GUI widget displaying the at least one summary statistic pertaining to the individual preference set.

10. The method of claim 1, further comprising transmitting a computer-readable representation of at least one persona of a second matchable entity of the PME corresponding to at least one preference set of the PPS to at least one electronic device associated with the first user, the second matchable entity associated with a second user of the PU.

11. The method of claim 4, further comprising transmitting a computer-readable representation of results pertaining to an evaluation of the first matchable entity against at least one preference set associated with a second matchable entity of the PME to at least one electronic device associated with the first user, the second matchable entity associated with a second user of the PU.

12. The method of claim 1, further comprising facilitating engagement between the first matchable entity and a second matchable entity of the PME, the second matchable entity associated with a second user of the PU, the engagement occurring through at least one electronic device associated with the first user and at least one electronic device associated with the second user.

13. A system for entity matching, comprising:
at least one database (database) adapted to electronically store a plurality of matchable entity profiles (PMEP), the PMEP associated with a plurality of matchable entities (PME), the PME associated with a plurality of users (PU);
a plurality of electronic devices (PED) associated with the PU; and
a network adapted to connect the PU via the PED to a server, the server adapted to:
receive a plurality of preference sets (PPS) associated with a first matchable entity of the PME, the PPS electronically submitted by a first user of the PU using at least one electronic device, the first user associated with the first matchable entity, the PPS satisfying at least one of: all conforming to a first preference superset, all associating with a first mode, all associating with a first space, all associating with a first environment, all comprising related matching contexts, all comprising related intentions, all comprising related goals, all comprising related purposes, all relating to seeking professional connections, all relating to seeking employment, all relating to seeking platonic companions, and all relating to seeking at least one of romantic partners and sexual partners; and
perform at least one of:
transmit a computer-readable representation of at least one matchable entity of the PME that corresponds to at least one preference set of the PPS to at least one electronic device associated with the first user, hereafter referred to as matches;
transmit a computer-readable representation of zero matches to at least one electronic device associated with the first user; and
render a display representing zero matches on at least one electronic device associated with the first user.

14. The system of claim 13, wherein the PPS further satisfying at least one of: all having the same matching context; all having the same intention; all having the same goal; all having the same purpose; and all having a first configurable input, the first configurable input configured to a unique value for each preference set of the PPS by the first matchable entity using at least one electronic device, the unique value to the first configurable input of each preference set determining a unique list of matches for each preference set of the PPS.

15. The system of claim 13, wherein at least one electronic device associated with the first user is adapted to locally store the PPS in non-transitory memory.

16. The system of claim 13, wherein the database is further adapted to store the PME and PPS.

17. The system of claim 16, wherein a match has at least one preference set that is passed by the first matchable entity.

18. The system of claim 16, wherein a match has at least one preference set that comprises at least one matching context that is at least one of equal to, overlapping with, and compatible with at least one matching context of at least one preference set of the PPS that the match corresponds to.

19. The system of claim 16, wherein a match has at least one preference set that is passed by the first matchable entity and comprises at least one matching context that is at least one of equal to, overlapping with, and compatible with at least one matching context of at least one preference set of the PPS that the match corresponds to.

20. A non-transitory computer-readable medium storing instructions that, when executed by at least one processor, cause the at least one processor to perform operations comprising:
storing a plurality of matchable entity profiles (PMEP) in at least one database (database), the PMEP associated with a plurality of matchable entities (PME), the PME associated with a plurality of users (PU);
receiving a plurality of preference sets (PPS) associated with a first matchable entity of the PME, the PPS electronically submitted by a first user of the PU using at least one electronic device, the first user associated with the first matchable entity, the PPS satisfying at least one of: all conforming to a first preference superset, all associating with a first mode, all associating with a first space, all associating with a first environment, all comprising related matching contexts, all comprising related intentions, all comprising related goals, all comprising related purposes, all relating to seeking professional connections, all relating to seeking employment, all relating to seeking platonic companions, and all relating to seeking at least one of romantic partners and sexual partners; and
performing at least one of:
transmitting a computer-readable representation of at least one matchable entity of the PME that corresponds to at least one preference set of the PPS to at least one electronic device associated with the first user, hereafter referred to as matches;
transmitting a computer-readable representation of zero matches to at least one electronic device associated with the first user; and
rendering a display representing zero matches on at least one electronic device associated with the first user.
